(19) United States
(12) Patent Application Publication
(10) Pub. No.: US 2023/0352725 A1
(43) Pub. Date: Nov. 2, 2023

(54) COMPOSITION-OF-MATTER FOR EXTRUSION OF ELECTROCHEMICAL SYSTEM

(71) Applicant: Ramot at Tel-Aviv University Ltd., Tel-Aviv (IL)

(72) Inventors: Diana GOLODNITSKY, Tel-Aviv (IL); Heftsi RAGONES, Tel-Aviv (IL); Adi VINEGRAD, Tel-Aviv (IL); Moti Marcos DORFMAN, Tel-Aviv (IL); Gilat ARDEL, Tel-Aviv (IL)

(73) Assignee: Ramot at Tel-Aviv University Ltd., Tel-Aviv (IL)

(21) Appl. No.: 17/780,536

(22) PCT Filed: Nov. 27, 2020
(86) PCT No.: PCT/IL2020/051228

§ 371 Date: May 27, 2022

Related U.S. Application Data
(60) Provisional application No. 62/940,999, filed on Nov. 27, 2019.

(51) Int. Cl. H01M 10/056; H01M 10/0525; C08L 67/04; C08K 3/36; C08K 3/22; C08K 5/43; H01G 11/50; H01G 11/32; H01G 11/86

(52) U.S. Cl. CPC H01M 10/056; H01M 10/0525; C08L 67/04; C08K 3/36; C08K 3/22; C08K 5/43; H01G 11/50; H01G 11/32; H01G 11/86; H01M 2300/0091; C08K 2003/2227

(57) ABSTRACT

A composition-of-matter is described herein, comprising a first layer and third layer separated by a second layer. The first and third layers each comprise a thermoplastic polymer and a substance capable of reversibly releasing lithium or a delithiated form of the substance. The second layer comprises a thermoplastic polymer and is capable of conducting lithium ions. Further described herein is an electrochemical system comprising the composition-of-matter, wherein the first and third layers are each a lithium-based electrode, and batteries and supercapacitors comprising such an electrochemical system, as well as methods for preparing the composition-of-matter or the electrochemical system.

### RELATED APPLICATION/S

This application claims the benefit of priority of U.S. Provisional Patent Application No. 62/940,999 filed on Nov. 27, 2019, the contents of which are incorporated herein by reference in their entirety.

### FIELD AND BACKGROUND OF THE INVENTION

The present invention, in some embodiments thereof, relates to additive manufacturing, and more particularly, but not exclusively, to compositions and methods usable in additive manufacturing of electrochemical systems such as, but not limited to, batteries.

Efforts have been exerted towards the development of three-dimensional microbatteries [Roberts et al., J Mater Chem 2011, 21:9876-9890; Nathan et al., J Microelectromechanical Syst 2005, 14:879-885]. The power output of a three-dimensional microbattery are expected to be up to two orders of magnitude higher than of a two-dimensional battery of equal size, as a result of the higher ratio of electrode-surface-area to volume and lower ohmic losses. Within a battery electrode, a 3D architecture gives mesoporosity, increasing power by reducing the length of the diffusion path; in the separator region it can form the basis of a robust but porous solid, isolating the electrodes and immobilizing an otherwise fluid electrolyte.

Furthermore, the progress made in flexible electronics such as roll-up displays and wearable electronics would receive a strong stimulus with the development of bendable/twistable batteries.
Some proposed 3D architectures include the use of vertical “posts” connected to a substrate, in which the layered battery structure is formed around the posts. Other architectures are based on the deposition of electrodes and electrolyte layers on a graphite mesh current collector for anode and cathode or on perforated silicon, glass or polymer substrates [Roberts et al., J Mater Chem 2011, 21:9876-9890; Cohen et al., Electrochim Acta 2018, 265:690-701].
Despite extensive efforts in the field, the performance of current 3D-printed batteries is still far from those of the state-of-the-art commercial batteries, in which the electrodes are fabricated by conventional doctor-blade casting technique. The development of all-3D-printed electrochemical devices is hindered by several technical issues such as nozzle clogging, particles aggregation in printing media, insufficient printer resolution, large electrode thickness and rough surface finish of printed parts [Nathan et al., J Microelectromechanical Syst 2005, 14:879-885].
Rao et al. [Nano Energy 2018, 51:425-433] describe a flexible, all-fiber-based lithium-ion battery, wherein the anode is made up of porous rGO (reduced graphene oxide) fiber with SnO₂ quantum dots, the cathode consists of spring-shaped rGO fiber with LiCoO₂, and the battery capacity is 82.6 mAh/g.
Kwon et al. [Advanced Materials 2012, 24:5192-5197] describe a cable-type battery with hollow-spiral, multiple-helix electrodes surrounded by a tubular outer electrode, wherein the anode is copper wire has been coated by Sn—Ni alloy and the cathode is formed from LiCoO₂-based slurry on aluminum wire.
Yu & Thomas [Advanced Materials 2014, 26:4279-4285] describe a coaxial supercapacitor cable using CuO/AuPd/MnO₂ core-shell nanowhiskers on copper wire and copper foil as inner and outer electrodes, respectively.
Yang et al. [Angewandte Chemie Int Ed 2013, 52:13453-13457] describe a stretchable supercapacitor with two layers of sheets built of aligned carbon nanotubes, which serve as two electrodes, wrapped around an elastic fiber.
Le et al. [ACS Nano 2013, 7:5940-5947] describe a coaxial fiber supercapacitor which consists of carbon microfiber bundles coated with multi-walled carbon nanotubes as a core electrode and carbon nanofiber paper as an outer electrode.
Chen et al. [Advanced Materials 2013, 25:6436-6441] describe coaxial capacitor fibers developed from aligned carbon nanotube fiber and sheet, which function as two electrodes with a polymer gel sandwiched between them.
Chang et al. [J Mater Chem A 2019, 7:4230-4258] reviews 3D-printed electrochemical energy storage devices, discussing the strengths and weaknesses of various printing techniques.
International Patent Applicant Publication WO 2019/202600 describes a method of manufacturing an electrochemical system comprising an electrode, by dispensing, in a configured pattern corresponding to the shape of the electrode, a model composition which comprises a substance capable of reversibly releasing an electrochemically-active agent (such as lithium) or depleted form of same, wherein dispensing comprises heating a filament comprising the model composition and dispensing a heated composition.
U.S. Pat. No. 7,700,019 describes a process of co-extrusion of a thin electrode sheet with a thin electrolyte polymer sheet directly onto a current collector sheet for a lithium polymer battery. Each sheet is formed from a respective slurry comprising a polymer and a lithium salt, the electrode slurry further comprising an electronic conductive material.
Additional background art includes Chen & Xue [J Mater Chem A 2016, 4:7522-7537]; Golodnitsky et al. [J Power Sources 2006, 153:281-287]; Long et al. [Chem Rev 2004, 104:4463-4492]; Nishide & Oyaizu [Science 2008, 519:737-738]; Ragones et al. [Sustainable Energy Fuels 2018, 2:1542-1549] and Wang et al. [Materials Today 2015, 18:265-272].

### SUMMARY OF THE INVENTION

According to an aspect of some embodiments of the invention, there is provided a composition-of-matter comprising:
a first layer which comprises a first thermoplastic polymer and a substance capable of reversibly releasing lithium or a delithiated form of the substance,
a second layer comprising a second thermoplastic polymer and being capable of conducting lithium ions, and
a third layer which comprises a third thermoplastic polymer and a substance capable of reversibly releasing lithium or a delithiated form of the substance,
wherein the first layer and the third layer are separated by the second layer.

According to some of any of the embodiments of the invention, the composition-of-matter is in a form of a film.

According to some of any of the embodiments of the invention, the composition-of-matter is in a form of a film, and the first layer, the second layer and the third layer are in a form of sheets parallel to the film.

According to some of any of the embodiments of the invention, the composition-of-matter is in a form of a filament.

According to an aspect of some embodiments of the invention, there is provided a composition-of-matter in a form of a filament, comprising:
a first layer which comprises a first thermoplastic polymer and a substance capable of reversibly releasing lithium or a delithiated form of the substance,
a second layer comprising a second thermoplastic polymer and being capable of conducting lithium ions, and
a third layer which comprises a third thermoplastic polymer and a substance capable of reversibly releasing lithium or a delithiated form of the substance,
wherein the first layer and the third layer are separated by the second layer.

According to some of any of the embodiments of the invention relating to a filament, the first layer, the second layer and the third layer are coaxial.

According to some of any of the embodiments of the invention, the composition-of-matter further comprises at least one layer comprising a substance capable of serving as a current collector, each of the at least one layer being in contact with the first layer and/or the third layer.

According to some of any of the embodiments of the invention, at least 20 weight percents of the first layer is the first thermoplastic polymer, at least 20 weight percents of the second layer is the second thermoplastic polymer, and/or at least 20 weight percents of the third layer is the third thermoplastic polymer.

According to some of any of the embodiments of the invention, the first thermoplastic polymer, the second thermoplastic polymer and/or the third thermoplastic polymer are selected from the group consisting of acrylonitrile butadiene styrene, polylactic acid, polyethylene terephthalate, a polycarbonate, a polyamide, a polyurethane, polystyrene, polyvinyl alcohol, polyvinylpyrrolidone, polyacrylic acid or a salt thereof, polymethyl methacrylate, polyvinylidene fluoride, polyvinylidene chloride, polyethylene, polypropylene, polyethylene oxide, carboxymethylcellulose or a salt thereof, lignin, rubber, and copolymers thereof.

According to some of any of the embodiments of the invention, the second thermoplastic polymer comprises a mixture of polylactic acid and polyethylene oxide.

According to some of any of the embodiments of the invention, the second layer comprises a substance selected from the group consisting of silica and alumina.

According to some of any of the embodiments of the invention, the second layer comprises a lithium salt.

According to some of any of the embodiments of the invention relating to a lithium salt, the lithium salt is selected from the group consisting of lithium bistriflimide, lithium tetrafluoroborate, lithium hexafluorophosphate and a lithium halide.

According to some of any of the embodiments of the invention relating to a lithium salt, the lithium salt is lithium bistriflimide.

According to some of any of the embodiments of the invention, the first thermoplastic polymer and/or the third thermoplastic polymer comprises polylactic acid.

According to some of any of the embodiments of the invention, the first layer and/or the third layer further comprises a lithium salt.

According to some of any of the embodiments of the invention, the first layer and/or the third layer further comprises an electrically conductive substance.

According to some of any of the embodiments of the invention relating to an electrically conductive substance, the electrically conductive substance comprises carbon particles.

According to an aspect of some embodiments of the invention, there is provided a composition comprising a second thermoplastic polymer, the composition being capable of conducting lithium ions, according to any of the embodiments described herein relating to a second layer.

According to an aspect of some embodiments of the invention, there is provided a method of preparing a composition-of-matter described herein according to any of the respective embodiments, the method comprising co-extruding the first layer, the second layer and the third layer.

According to an aspect of some embodiments of the invention, there is provided a method of manufacturing an electrochemical system which comprises at least two lithium-based electrodes and optionally at least one current collector, the method comprising dispensing a composition-of-matter described herein according to any of the respective embodiments, wherein dispensing comprises co-extruding the first layer, the second layer and the third layer, and the first layer and the third layer each form a lithium-based electrode of the electrochemical system.

According to some of any of the embodiments of the invention relating to a method, the composition-of-matter further comprises at least one layer comprising a substance capable of serving as a current collector, and the method further comprises co-extruding the at least one layer comprising a substance capable of serving as a current collector with the first layer, the second layer and the third layer.

According to an aspect of some embodiments of the invention, there is provided an electrochemical system comprising a composition-of-matter described herein according to any of the respective embodiments, wherein the first layer and the third layer are each a lithium-based electrode.

According to an aspect of some embodiments of the invention, there is provided an electrochemical system prepared according to a method of manufacturing an electrochemical system described herein any, according to any of the respective embodiments.

According to an aspect of some embodiments of the invention, there is provided a battery comprising at least one electrochemical system described herein according to any of the respective embodiments, wherein the first layer and the third layer comprise different substances capable of reversibly releasing lithium or a delithiated form of the substances.

According to some of any of the embodiments of the invention relating to a battery, the substance capable of reversibly releasing lithium in an anode of the battery is selected from the group consisting of lithium titanate (LTO) and a lithium alloy.

According to some of any of the embodiments of the invention relating to a battery, the substance capable of reversibly releasing lithium in a cathode of the battery is a lithium metal oxide/sulfide.

According to an aspect of some embodiments of the invention, there is provided a supercapacitor comprising at least one electrochemical system described herein according to any of the respective embodiments.

According to some of any of the embodiments of the invention relating to a supercapacitor, the first layer and the third layer comprise the same substance capable of reversibly releasing lithium or a delithiated form of the substance.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B present images of an exemplary disc-shape printed solid electrolyte (FIG. 1A) and extrusion of a filament for printing a cathode (FIG. 1B).

FIGS. 2A-2F present scanning electron microscopy images of exemplary samples of printed polymeric samples: neat PLA (FIG. 2A), PLA:PEO:PEG blend at 25:40:35 ratio (FIG. 2B), planar (FIG. 2C) and cross-sectional (FIG. 2E) view of PLA:PEO:LiTFSI:SiO₂ (59:20:20:1 ratio) solid electrolyte, and planar (FIG. 2D) and cross-sectional (FIG. 2F) view of PLA:PEO:LiTFSI:Al₂O₃ (59:20:20:1 ratio) solid electrolyte (scale bar represents 50.0 μm in FIGS. 2A-2D and 200 μm in main image of FIGS. 2E and 2F).

FIGS. 3A-3D present differential scanning calorimetry thermograms of exemplary polymeric samples: pristine PEO and cast PEO:LiTFSI (FIG. 3A), pristine PLA and cast PLA:LiTFSI (FIG. 3B), filaments of PEO:PLA blend with LiTFSI containing silica and alumina or free of ceramic additives (FIG. 3C), and cast, filament and printed PLA-PEO-LiTFSI:SiO₂ (FIG. 3D).

FIGS. 4A-4E present portions of mass spectrum of exemplary 3D printed PLA-PEO-LiTFSI 1% SiO₂ solid electrolyte, with peaks associated with PEO (FIG. 4A) and PLA (FIGS. 4B-4E).

FIGS. 5A-5F present TOF-SIMS images of exemplary 3D printed PLA-PEO-LiTFSI 1% SiO₂ solid electrolyte, for C₂H₅O⁺ (FIG. 5A) and C₃H₄O⁺ (FIG. 5B) fragments and their overlap (FIG. 5C), and for C₂H₃OLi⁺ (FIG. 5D) and C₂H₄OLi⁺ (FIG. 5E) fragments and their overlap (FIG. 5F).

FIG. 6 presents a representative Nyquist plot of an exemplary composite 3D-printed solid electrolyte comprising PLA, PEO, LiTFSI and Al₂O₃ and the equivalent circuit model (inset) used to generate a fit to the data.

FIGS. 7A-7C present Arrhenius plots of bulk (FIG. 7A) and grain boundary (GB) (FIG. 7B) conductivity, and resistance of the solid electrolyte interphase (R_{SEI}) as a function of temperature (FIG. 7C), for an exemplary solid electrolyte comprising PLA, PEO, LiTFSI and SiO₂.

FIG. 8 presents a charge/discharge profile of an exemplary printed electrochemical cell comprising LFP and LTO electrodes and a PLA-PEO-LiTFSI-1% SiO₂ solid electrolyte, over consecutive ten cycles.

FIGS. 9A and 9B present schematic depictions of a battery in a form of a multi-coaxial filament, according to some embodiments of the invention (FIG. 9A), as well as optional configurations of such a filament (FIG. 9B).

FIG. 10 presents a schematic depiction (cross-section) of an extrusion nozzle for preparing a multi-coaxial filament according to some embodiments of the invention.

### DESCRIPTION OF SPECIFIC EMBODIMENTS OF THE INVENTION

The present invention, in some embodiments thereof, relates to additive manufacturing, and more particularly, but not exclusively, to compositions and methods usable in additive manufacturing of electrochemical systems such as, but not limited to, batteries.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

While lithium ion-based electrochemical systems such as lithium ion batteries and supercapacitors are associated with high energy density, the design and fabrication processes of such systems is typically complex and labor-consuming.

The present inventors have surprisingly uncovered that the various components of lithium ion-based electrochemical systems, such as electrodes, electrolyte layer and optionally current collectors, may be formed from compositions which are readily shaped by processes such as extrusion and 3D-printing, using thermoplastic polymers. This allows for the relatively simple manufacture of a lithium ion-based electrochemical system using a suitable extrusion and/or printing device, along with a high degree of design flexibility. Increased interfacial areas between electrodes and solid electrolyte and/or current collector may significantly facilitate ion transfer by reducing tortuosity in the migration pathway of lithium ions and/or reducing resistance to electron conductivity, thereby enhancing efficiency and/or energy density.

While reducing the present invention to practice, the inventors have prepared an all-solid-state electrolyte suitable for being 3D-printed. Exemplary 3D-printed electrolytes were analyzed by various techniques and exhibited bulk ionic conductivity of 3×10⁻⁵ S/cm at 90° C. and 156 ohm/cm² resistance of the solid electrolyte interphase (SEI). Such solid electrolytes are of particular significance, as even “printed” batteries have heretofore tended to utilize self-standing commercial polymer membranes, followed by soaking in non-aqueous liquid electrolytes, in combination with printed electrodes.

The technology described herein can allow the fabrication of free form-factor energy-storage devices with readily controllable geometries, and may allow the direct integration of such devices in a wide range of applications, such as portable, wearable and flexible electronics, and medical devices and personalized instruments. Additive manufacturing (including, but not limited to, fused filament fabrication (FFF)) allows a rapid change in the design without requiring modification of the manufacturing process.

In addition, the use of polymer-based layers, which may be quite thin, further facilitates the manufacture of mechanically flexible (e.g., bendable and/or twistable) electrochemical systems, which may be used, e.g., in flexible electronics such as roll-up displays and wearable electronics.

According to an aspect of some embodiments of the invention, there is provided a composition-of-matter comprising at least three layers, including a first layer, a second layer, and a third layer, each of which comprise a thermoplastic polymer.

The first layer comprises a first thermoplastic polymer and a substance capable of reversibly releasing lithium or a delithiated form of the substance.

The second layer comprises a second thermoplastic polymer and the layer is capable of conducting lithium ions. A layer capable of conducting lithium ions is also referred to herein interchangeably as a “solid electrolyte”.

The third layer comprises a third thermoplastic polymer and a substance capable of reversibly releasing lithium or a delithiated form of the substance. The third layer may optionally be the same in composition as the first layer or different; the third thermoplastic polymer may be the same as or different than the first thermoplastic polymer, and the substance capable of reversibly releasing lithium (or delithiated form thereof) of the third layer may be the same as or different than the substance capable of reversibly releasing lithium (or delithiated form thereof) of the first layer.

In some of any of the embodiments described herein, the composition-of-matter comprises at least one layer comprising a substance capable of serving as a current collector, as discussed in more detail herein.

Herein, the term “layer” refers to a region of a composition-of-matter having a composition distinct from that of adjacent regions and which is thin in at least one dimension, such that a length of the region in such a dimension is no more than 10%, optionally no more than 1%, optionally no more than 0.1%, and optionally no more than 0.01% a length in at least one other dimension of the layer. Thus, a “layer” described herein may optionally be, e.g., sheet-like (being thin in one dimension and long in two dimensions), thread-like (being thin in two dimensions and long in one dimension), or have a more complex shape, such as a cylindrical shape.

It is to be appreciated that a layer may optionally have a composition which is not distinct from that of a non-adjacent region; for example, a first layer and third layer may optionally have the same composition, while being non-adjacent to one another (e.g., separated by the second layer).

In some of any of the embodiments described herein, one or more of the layers described herein (optionally each of the layers) has a width of no more than 3 mm, optionally no more than 2 mm, optionally no more than 1 mm, optionally no more than 0.5 mm, optionally no more than 0.3 mm, optionally no more than 0.2 mm, and optionally no more than 0.1 mm.

The thermoplastic polymer may, for example, facilitate extrusion of one or more of the layers, and optionally extrusion (e.g., co-extrusion) of all of the layers.

The first, second and third layers are preferably extrudable substances.

Herein, the term “extrudable” refers to a substance which can be in a sufficiently soft state to be pushed (“extruded”) through a small hole (“die”) to form a shape with a cross-section corresponding to the shape of the hole, followed by hardening to maintain said shape. The soft state may be obtained for example, by heating, and the hardening may be obtained by cooling.

In some of any of the embodiments described herein, the composition-of-matter is in a form of a film, for example, wherein the first layer, second layer and third layer (according to any of the respective embodiments described herein) are in a form of sheets parallel to the film (that is, the plane of each sheet is substantially parallel to the plane the film).

In some of any of the embodiments described herein, the composition-of-matter is in a form of a filament, for example, wherein various layers are coaxial (e.g., one “layer” forms a central region, and the other layers form successively wider substantially cylindrical shapes around the central region). In some embodiments, at least the first layer, second layer and third layer (according to any of the respective embodiments described herein) are coaxial. In some embodiment, a layer comprising a substance capable of serving as a current collector forms a central region of the coaxial filament.

Alternatively, layers in a filament may have a non-coaxial configuration, for example, parallel sheet-like layers (e.g., as described herein with respect to a film), or multiple layers (e.g., with an approximately wedge-shaped cross-section) which each comprise a portion of the surface of the filament (e.g., such that interface between layers is approximately perpendicular to the surface of the filament).

In some of any of the embodiments described herein, the composition-of-matter has a three-dimensional shape, that is, the shape of the electrode cannot be fully represented by a two-dimensional pattern (e.g., a two-dimensional cross-section which is constant along a particular axis). Such a three-dimensional shape may be, for example, a filament and/or film in a twisted (e.g., substantially helical) configuration.

The composition-of-matter of any of the respective embodiments of the invention may optionally be in a form of a feedstock suitable for use in any suitable method of manufacture. Optionally the composition-of-matter, upon manufacture, forms electrodes and a solid electrolyte of an electrochemical system, whereas one or more additional materials are used to provide other components (e.g., structural components).

For example, a composition-of-matter in a form of a filament (according to any of the respective embodiments described herein) may optionally be used as a feedstock for fused filament fabrication (FFF), whereby the filament is heated and dispensed (using any suitable technique and/or device known in the art) in a controlled configuration. Optionally, the FFF comprises utilizing one or more additional filaments to provide other components (e.g., structural components).

It is expected that during the life of a patent maturing from this application many relevant fused filament fabrication techniques and devices will be developed and the scope of the term “fused filament fabrication” is intended to include all such new technologies a priori.

Additionally or alternatively, a composition-of-matter (e.g., in a form of a film) may optionally be subjected to any techniques for manipulating a feedstock, such as cutting, bending and/or folding (with or without heating to soften the composition-of-matter), coating (e.g., being subjected to spray coating and/or dip coating), and/or gluing to additional components (with or without heating to enhance adhesiveness).

In addition, the composition-of-matter of any of the respective embodiments of the invention may optionally be in a manufactured form (e.g., obtainable by any of the techniques described herein), for example, within a system which comprises one or more additional materials in addition to the composition-of-matter.

Solid Electrolyte:

The thermoplastic polymer of the solid electrolyte (referred to herein as the second thermoplastic polymer) may optionally comprise a mixture (e.g., blend) of distinct types of polymer.

In some of any of the respective embodiments described herein, a concentration of second thermoplastic polymer in the second layer is at least 20 weight percents, e.g., from 20 to 95 weight percents, or from 20 to 90 weight percents, or from 20 to 80 weight percents, or from 20 to 70 weight percents, or from 20 to 60 weight percents. In some such embodiments, the concentration of second thermoplastic polymer in the second layer is at least 30 weight percents, e.g., from 30 to 95 weight percents, or from 30 to 90 weight percents, or from 30 to 80 weight percents, or from 30 to 70 weight percents, or from 30 to 60 weight percents. In some embodiments, the concentration of second thermoplastic polymer in the second layer is at least 40 weight percents, e.g., from 40 to 95 weight percents, or from 40 to 90 weight percents, or from 40 to 80 weight percents, or from 40 to 70 weight percents, or from 40 to 60 weight percents. In some embodiments, the concentration of second thermoplastic polymer in the second layer is at least 50 weight percents, e.g., from 50 to 95 weight percents, or from 50 to 90 weight percents, or from 50 to 80 weight percents, or from 50 to 70 weight percents. In some embodiments, the concentration of second thermoplastic polymer in the second layer is at least 50 weight percents, e.g., from 50 to 95 weight percents, or from 50 to 90 weight percents, or from 50 to 80 weight percents, or from 50 to 70 weight percents. In some embodiments, the concentration of second thermoplastic polymer in the second layer is at least 60 weight percents, e.g., from 60 to 95 weight percents, or from 60 to 90 weight percents, or from 60 to 80 weight percents. In some embodiments, the concentration of second thermoplastic polymer in the second layer is at least 70 weight percents, e.g., from 70 to 95 weight percents, or from 70 to 90 weight percents. In exemplary embodiments, the concentration of second thermoplastic polymer in the second layer is about 80 weight percents.

Examples of thermoplastic polymers (which may be used individually or in combination) suitable for use in any of the embodiments described herein relating to a second thermoplastic polymer include, without limitation, acrylonitrile butadiene styrene, polylactic acid, polyethylene terephthalate, polycarbonates, polyamides, polyurethanes, polystyrene, polyvinyl alcohol, polyvinylpyrrolidone, polyacrylic acid (or a salt thereof), polymethyl methacrylate, polyvinylidene fluoride, polyvinylidene chloride, polyethylene, polypropylene, polyethylene oxide, carboxymethylcellulose (or a salt thereof), lignin and rubber, including copolymers of two or more of any of the foregoing.

Further polymers which may optionally be included in the second thermoplastic polymer include, for example, polytetrafluoroethylene, polysulfones, polyimides, polyethylene imine (PEI), polyethers (e.g., polyphenylene oxide (PPO)), polybenzimidazole, and polyphenylene (PP), including copolymers thereof (e.g., poly(ethylenetetrafluoroethylene) (ETFE)).

The second thermoplastic polymer is optionally extrudable (as defined herein), that is, the polymer per se is extrudable.

The second thermoplastic polymer comprised by the solid electrolyte may optionally comprise polylactic acid and/or polyethylene oxide. In some of any of the respective embodiments, the second thermoplastic polymer comprises a mixture of polylactic acid and polyethylene oxide. The polyethylene oxide may optionally comprise low molecular weight polyethylene glycol, e.g., having a molecular weight of 3,000 Da or less.

Herein throughout, the terms “polyethylene glycol”, “PEO”, “polyethylene oxide” and “PEG” are used interchangeably, and each encompass a polymer of any molecular weight. In some passages herein, low molecular weight forms are referred to herein as “polyethylene glycol” and higher molecular weight forms are referred to as polyethylene oxide”, but such usage is merely for convenience, and is not intended to be limiting.

Without being bound by any particular theory, it is believed that polyethylene oxide provides a considerable degree of lithium ion conductivity, whereas polylactic acid provides enhanced mechanical properties and high-temperature durability (as polyethylene oxide per se is not particularly suitable for extrusion or printing). It is further believed that polylactic acid may contribute to a significant extent to lithium ion conductivity, as the coordination mechanism of the lithium cation by the oxygen of the polylactic acid chain is similar to that of polyethylene oxide and local relaxation motions of polylactic acid chain segments may promote lithium ion hopping between oxygens of adjacent CH—O groups. This is supported by evidence of complexation of lithium to polylactic acid, as presented in the Examples section below.

In some of any of the embodiments described herein relating to a mixture of polylactic acid and polyethylene oxide, a weight ratio of polylactic acid to polyethylene oxide in the mixture is in a range of from 10:1 to 1:10, optionally from 5:1 to 1:5, and optionally from 3:1 to 1:3.

In some of any of the embodiments described herein relating to a mixture of polylactic acid and polyethylene oxide, an amount of polylactic acid is at least as great as (e.g., at least two-fold) that of polyethylene oxide. In some such embodiments, a weight ratio of polylactic acid to polyethylene oxide in the mixture is in a range of from 1:1 to 10:1 (e.g., from 1:1 to 5:1), and optionally in a range of from 2:1 to 10:1 (e.g., from 2:1 to 5:1). In some exemplary embodiments, a weight ratio of polylactic acid to polyethylene oxide in the mixture is about 3:1.

In some of any of the respective embodiments described herein, a concentration of polylactic acid in the second layer is at least 20 weight percents, e.g., from 20 to 80 weight percents, or from 20 to 60 weight percents, or from 20 to 40 weight percents (for example, a second thermoplastic polymer comprising at least 30 weight percents of polylactic acid and polyethylene oxide, wherein a ratio of polylactic acid to polyethylene oxide is at least 2:1, will have a polylactic acid concentration of at least 20 weight percents). In some such embodiments, the concentration of polylactic acid in the second layer is at least 30 weight percents, e.g., from 30 to 80 weight percents, or from 30 to 60 weight percents. In some embodiments, the concentration of polylactic acid in the second layer is at least 40 weight percents, e.g., from 40 to 80 weight percents, or from 40 to 60 weight percents. In some embodiments, the concentration of polylactic acid in the second layer is at least 50 weight percents, e.g., from 50 to 80 weight percents, or from 50 to 70 weight percents. In some embodiments, the concentration of polylactic acid in the second layer is at least 60 weight percents, e.g., from 60 to 80. In some exemplary embodiments, the concentration of polylactic acid in the second layer is about 60 weight percents. In some of any of the aforementioned embodiments, the second thermoplastic polymer further comprises polyethylene oxide (e.g., such that the total concentration of second thermoplastic polymer is as described herein according to any of the respective embodiments).

In some of any of embodiments described herein, the second layer comprises (in addition to thermoplastic polymer) at least one compound comprising lithium ions. The compound(s) may optionally comprise a lithium salt (e.g., comprising lithium and an anion such as bis(trifluoromethylsulfonyl)imide (also known in the art as “bistriflimide”), tetrafluoroborate, hexafluorophosphate and/or halide) and/or a ceramic comprising lithium ions (e.g., LAGP (Li_{1.5}Al_{0.5}Ge_{1.5}P₃O₁₂) or LLZO (Li₇La₃Zr₂O₁₂) garnet). Lithium bistriflimide is an exemplary lithium salt.

The lithium ion-containing compound according to any of the respective embodiments may optionally enhance lithium ion conductivity of the second layer, e.g., facilitating its use as a solid electrolyte of an electrochemical system.

In some of any of respective embodiments described herein, a total concentration of the (one or more) lithium ion-containing compound (e.g., lithium salt) is at least about 5 weight percents. In some embodiments, a total concentration of lithium ion-containing compound (e.g., lithium salt) in the second layer is at least about 10 weight percents. In some embodiments, a total concentration of lithium ion-containing compound (e.g., lithium salt) in the second layer is at least about 20 weight percents. In some embodiments, a total concentration of lithium ion-containing compound (e.g., lithium salt) in the second layer is at least about 30 weight percents. In some of any of the aforementioned embodiments, the compound is lithium bistriflimide.

In some of any of the respective embodiments described herein, a total concentration of lithium ion-containing compound (e.g., lithium salt) in the second layer is no more than about 40 weight percents. In some such embodiments, the total concentration is in a range of from about 5 to about 40 weight percents. In some embodiments, the total concentration is in a range of from about 10 to about 40 weight percents. In some embodiments, the total concentration is in a range of from about 20 to about 40 weight percents. In some embodiments, the total concentration is in a range of from about 30 to about 40 weight percents. In some of any of the aforementioned embodiments, the compound is lithium bistriflimide.

In some of any of the respective embodiments described herein, a total concentration of lithium ion-containing compound (e.g., lithium salt) in the second layer is no more than about 30 weight percents. In some such embodiments, the total concentration is in a range of from about 5 to about 30 weight percents. In some embodiments, the total concentration is in a range of from about 10 to about 30 weight percents. In some embodiments, the total concentration is in a range of from about 20 to about 30 weight percents. In some of any of the aforementioned embodiments, the compound is lithium bistriflimide.

In some of any of the respective embodiments described herein, a total concentration of lithium ion-containing compound (e.g., lithium salt) in the second layer is no more than about 20 weight percents. In some such embodiments, the total concentration is in a range of from about 5 to about 20 weight percents. In some embodiments, the total concentration is in a range of from about 10 to about 20 weight percents. In some exemplary embodiments, the total concentration is about 20 weight percents. In some of any of the aforementioned embodiments, the compound is lithium bistriflimide.

In some of any of the respective embodiments described herein, a total concentration of second thermoplastic polymer and lithium ion-containing compound (e.g., lithium salt) in the second layer is at least 90 weight percents, optionally at least 95 weight percents, optionally at least 98 weight percents, and optionally at least 99 weight percents.

In some of any of the respective embodiments described herein, a total concentration of second thermoplastic polymer in the second layer is no more than 90 weight percents (according to any of the respective embodiments described herein), for example, from 40 to 90 weight percents, or from 50 to 90 weight percents, or from 60 to 90 weight percents, or from 70 to 90 weight percents, or from 80 to 90 weight percents. In some such embodiments, a concentration of lithium ion-containing compound (e.g., lithium salt) is at least 5 weight percents (e.g., from 5 to 40 weight percents, or from 5 to 30 weight percents, or from 5 to 20 weight percents, or from 5 to 10 weight percents), according to any of the respective embodiments described herein. In some embodiments, a concentration of lithium ion-containing compound (e.g., lithium salt) is at least 10 weight percents (e.g., from 10 to 40 weight percents, or from 10 to 30 weight percents, or from 10 to 20 weight percents), according to any of the respective embodiments described herein.

In some of any of the respective embodiments described herein, a total concentration of second thermoplastic polymer in the second layer is no more than 80 weight percents (according to any of the respective embodiments described herein), for example, from 40 to 80 weight percents, or from 50 to 80 weight percents, or from 60 to 80 weight percents, or from 70 to 80 weight percents. In some such embodiments, a concentration of lithium ion-containing compound (e.g., lithium salt) is at least 5 weight percents (e.g., from 5 to 40 weight percents, or from 5 to 30 weight percents, or from 5 to 20 weight percents, or from 5 to 10 weight percents), according to any of the respective embodiments described herein. In some embodiments, a concentration of lithium ion-containing compound (e.g., lithium salt) is at least 10 weight percents (e.g., from 10 to 40 weight percents, or from 10 to 30 weight percents, or from 10 to 20 weight percents), according to any of the respective embodiments described herein. In some embodiments, a concentration of lithium ion-containing compound (e.g., lithium salt) is at least 20 weight percents (e.g., from 20 to 40 weight percents, or from 20 to 30 weight percents), according to any of the respective embodiments described herein.

In some of any of the respective embodiments described herein, a total concentration of second thermoplastic polymer in the second layer is no more than 70 weight percents (according to any of the respective embodiments described herein), for example, from 40 to 70 weight percents, or from 50 to 70 weight percents, or from 60 to 70 weight percents. In some such embodiments, a concentration of lithium ion-containing compound (e.g., lithium salt) is at least 5 weight percents (e.g., from 5 to 40 weight percents, or from 5 to 30 weight percents, or from 5 to 20 weight percents, or from 5 to 10 weight percents), according to any of the respective embodiments described herein. In some embodiments, a concentration of lithium ion-containing compound (e.g., lithium salt) is at least 10 weight percents (e.g., from 10 to 40 weight percents, or from 10 to 30 weight percents, or from 10 to 20 weight percents), according to any of the respective embodiments described herein. In some embodiments, a concentration of lithium ion-containing compound (e.g., lithium salt) is at least 20 weight percents (e.g., from 20 to 40 weight percents, or from 20 to 30 weight percents), according to any of the respective embodiments described herein. In some embodiments, a concentration of lithium ion-containing compound (e.g., lithium salt) is at least 30 weight percents (e.g., from 30 to 40 weight percents), according to any of the respective embodiments described herein.

The second layer may optionally further comprise at least one additional ingredient (e.g., a non-thermoplastic solid), optionally dispersed within the second thermoplastic polymer. In some such embodiments, the additional ingredient is a granular solid, optionally comprising nanoparticles. Examples of suitable additional ingredients include, without limitation, ceramics. Silica (SiO₂) and alumina (Al₂O₃) are exemplary ceramics (for serving as an additional ingredient).

The additional ingredient(s) may, for example, enhance mechanical properties of the second thermoplastic polymer (e.g., by reducing ductility). In exemplary embodiments, the suitability of the components of the second layer for undergoing extrusion is enhanced by the additional ingredient(s).

In some of any of the embodiments, a total concentration of additional ingredient(s) (according to any of the respective embodiments described herein) in the second layer is at least 0.1 weight percent (e.g., from 0.1 to 10 weight percent, or from 0.1 to 5 weight percent, or from 0.1 to 2 weight percent, or from 0.1 to 1 weight percent). In some such embodiments, a total concentration of additional ingredient(s) in the second layer is at least 0.2 weight percent (e.g., from 0.2 to 10 weight percent, or from 0.2 to 5 weight percent, or from 0.2 to 2 weight percent, or from 0.2 to 1 weight percent). In some embodiments, a total concentration of additional ingredient(s) in the second layer is at least 0.5 weight percent (e.g., from 0.5 to 10 weight percent, or from 0.5 to 5 weight percent, or from 0.5 to 2 weight percent, or from 0.5 to 1 weight percent). In some embodiments, a total concentration of additional ingredient(s) in the second layer is at least 1 weight percent (e.g., from 1 to 10 weight percent, or from 1 to 5 weight percent, or from 1 to 2 weight percent).

The use of a solid electrolyte is advantageous in comparison to the use of conventional non-aqueous liquid and ionic liquid electrolytes (e.g., in combination with printed electrodes as described in International Patent Applicant Publication WO 2019/202600) in that such liquid electrolytes present a considerable safety concern (e.g., due to flammability and/or toxicity), and also creates difficulties in filling many small electrochemical systems (e.g., microbatteries) with very small (e.g., nanoliter) amounts of electrolyte.

According to an aspect of some embodiments of the invention, there is provided a composition comprising components of a solid electrolyte described herein, according to any of the respective embodiments; for example, a second thermoplastic polymer described herein and a lithium-ion containing compound described herein (according to any of the respective embodiments), optionally with at least one additional ingredient described herein (according to any of the respective embodiments), such as silica or alumina. Such a composition may optionally be used to form a solid electrolyte, including, without limitation, a second layer of a composition-of-matter described herein.

Substance Capable of Reversibly Releasing Lithium:

The first layer and/or third layer (e.g., according to any of the respective embodiments described herein) may each independently comprise (in addition to a thermoplastic polymer and optional additional ingredients such as described herein) a substance capable of reversibly releasing lithium (or delithiated form thereof) according to any of the embodiments described in this section. For convenience, substances capable of reversibly releasing lithium are described in detail herein. However, for any of the embodiments described herein relating to lithium, the lithium may optionally be partially or entirely substituted by any other cation or cation-forming metal suitable for electrochemical systems such as described herein, optionally any alkali metal other than lithium (e.g., sodium).

Herein, the phrase “substance capable of reversibly releasing lithium” refers to a substance as described herein, which encompasses a first form of the substance (e.g., an alloy and/or salt of lithium) which has a relatively high lithium content, a second form of the substance (also referred to herein interchangeably as the “delithiated” form) having a relatively low (optionally zero or close to zero, for example, less than 10% by molar concentration) lithium content (e.g., an alloy or salt having a low lithium content or the compound or element which forms an alloy or salt with lithium), and all forms of the substance having an intermediate lithium content.

The amount of lithium which can be released and absorbed by a substance may be represented as the difference between an amount of lithium in the abovementioned first form of the substance and an amount of lithium in the abovementioned second form of the substance.

According to some embodiments of any one of the embodiments described herein, a concentration of lithium in the first form of the substance is greater than a concentration of lithium in the second (delithiated) form of the substance by at least 0.005 moles per cm³ (e.g., from 0.005 to 0.1 moles/cm³, or from 0.005 to 0.05 moles/cm³). In some embodiments, a concentration of lithium in the first form of the substance is greater than a concentration of lithium in the second form of the substance by at least 0.01 moles per cm³ (e.g., from 0.01 to 0.1 moles/cm³, or from 0.01 to 0.05 moles/cm³). In some embodiments, a concentration of lithium in the first form of the substance is greater than a concentration of lithium in the second form of the substance by at least 0.02 moles per cm³ (e.g., from 0.02 to 0.1 moles/cm³, or from 0.02 to 0.05 moles/cm³). In some embodiments, a concentration of lithium in the first form of the substance is greater than a concentration of lithium in the second form of the substance by at least 0.05 moles per cm³ (e.g., from 0.05 to 0.1 moles/cm³).

According to some embodiments of any one of the embodiments described herein, a weight percentage of lithium in the first form of the substance is greater than a weight percentage of lithium in the second (delithiated) form of the substance by at least 2% (e.g., from 2 to 70%, or from 2 to 30%, or from 2 to 10%), for example, wherein a weight percentage of lithium in the second form is no more than 1% and a weight percentage of lithium in the first form is at least 3% (e.g., from 3 to 70%, or from 3 to 30%, or from 3 to 10%). In some embodiments, a weight percentage of lithium in the first form of the substance is greater than a weight percentage of lithium in the second form of the substance by at least 5% (e.g., from 5 to 70%, or from 5 to 30%, or from 5 to 10%). In some embodiments, a weight percentage of lithium in the first form of the substance is greater than a weight percentage of lithium in the second form of the substance by at least 10% (e.g., from 10 to 70%, or from 10 to 30%). In some embodiments, a weight percentage of lithium in the first form of the substance is greater than a weight percentage of lithium in the second form of the substance by at least 20% (e.g., from 20 to 70%, or from 20 to 30%). In some embodiments, a weight percentage of lithium in the first form of the substance is greater than a weight percentage of lithium in the second form of the substance by at least 50% (e.g., from 50 to 70%).

According to some embodiments of any one of the embodiments described herein, a molar percentage of lithium the percentage of atoms which are atoms of lithium) in the first form of the substance is greater than a molar percentage of lithium in the second (delithiated) form of the substance by at least 20% (e.g., from 20 to 90%, or from 20 to 50%), for example, wherein a molar percentage of lithium in the second form is no more than 5% and a molar percentage of lithium in the first form is at least 25%. In some embodiments, a molar proportion of lithium in the first form of the substance is greater than a molar proportion of lithium in the second form of the substance by at least 30% (e.g., from 30 to 90%, or from 30 to 50%). In some embodiments, a molar proportion of lithium in the first form of the substance is greater than a molar proportion of lithium in the second form of the substance by at least 50% (e.g., from 50 to 90%). In some embodiments, a molar proportion of lithium in the first form of the substance is greater than a molar proportion of lithium in the second form of the substance by at least 75% (e.g., from 75 to 90%), for example, wherein a molar percentage of lithium in the second form is no more than 5% and a molar percentage of lithium in the first form is at least 80%.

Any substance that can incorporate variable amounts of lithium atoms is contemplated. In some embodiments, the substance is not carbon (e.g., graphite).

In some of any of the respective embodiments described herein, the substance capable of reversibly releasing lithium is a lithium metal oxide and/or a lithium metal sulfide (collective referred to herein for brevity as “oxide/sulfide”, which term is to be regarded as interchangeable with “oxide and/or sulfide”).

Herein, a “lithium metal oxide” refers to a compound (e.g., ceramic and/or salt) comprising (e.g., in stoichiometric amounts) at least one lithium atom, at least one metal atom other than lithium, and at least one oxygen atom.

Accordingly, a metal oxide is a delithiated form of a lithium metal oxide.

Optionally, the lithium metal oxide consists essentially of lithium, one or more metal other than lithium, and oxygen.

Alternatively or additionally, the lithium metal oxide and/or metal oxide (as defined herein) further comprises, for example, at least one additional species of atom (optionally covalently bound to the oxygen atom(s)) such as phosphorus and/or silicon, e.g., a lithium metal phosphate (e.g., lithium iron phosphate) and/or lithium metal silicate, or delithiated forms thereof.

Herein, a “lithium metal sulfide” refers to a compound (e.g., ceramic and/or salt) comprising (e.g., in stoichiometric amounts) at least one lithium atom, at least one metal atom other than lithium, and at least one sulfur atom. A sulfide according to any of the embodiments described herein may optionally correspond to an oxide according to any of the respective embodiments herein, wherein one or more (optionally all) of the oxygen atoms of the oxide are replaced by sulfur atoms.

Accordingly, a metal sulfide (as defined herein) is a delithiated form of a lithium metal sulfide.

Examples of suitable lithium metal oxides include, without limitation, lithium titanate (LTO; e.g., Li₄Ti₅O₁₂), lithium iron phosphate (LFP, e.g., LiFePO₄), lithium cobalt oxide (LCO; e.g., LiCoO₂), lithium manganese oxide (LMO; e.g., LiMn₂O₄), lithium nickel cobalt aluminum oxide (NCA; e.g., LiNiₓCo_{y}Al_{z}O₂, wherein x+y+z=1, and z is small, for example, less than 0.1), and lithium nickel manganese cobalt oxide (NMC; e.g., LiNiₓMn_{y}Co_{z}O₂, wherein x+y+z=1).

In any of the embodiments described herein relating to lithium metal oxide/sulfides, the metal oxide/sulfide may optionally be in a partially delithiated form (comprising less Li than a stoichiometry described herein) or in a delithiated form, being a metal oxide/sulfide capable of uptake of lithium ions to form a lithium metal oxide/sulfide (according to any of the respective embodiments described herein). Examples of such metal oxides include, without limitation, titanate (e.g., Ti₅O₁₂), iron phosphate (e.g., FePO₄), cobalt oxide (e.g., CoO₂), manganese oxide (e.g., Mn₂O₄), nickel cobalt aluminum oxide (e.g., NiₓCo_{y}Al_{z}O₂, wherein x+y+z=1, and z is small, for example, less than 0.1), and nickel manganese cobalt oxide (NMC; e.g., NiₓMn_{y}Co_{z}O₂, wherein x+y+z=1).

In some of any of the respective embodiments described herein, the substance capable of reversibly releasing lithium is a lithium alloy.

Herein, the term “alloy” refers to a mixture or solid solution composed of a metal (e.g., lithium) and one or more other elements, at any molar ratio of metal to the other element(s).

Herein, the term “lithium alloy” refers to an alloy (as defined herein) composed of lithium and one or more other elements. Preferably, the compound(s) or element(s) which forms an alloy with lithium is not another alkali metal. In some embodiments, the lithium alloy may comprise a single phase of lithium and the other element(s). The compound or element which forms an alloy with lithium may be an element or a mixture of elements (other than lithium).

Accordingly, a compound which forms an alloy with lithium is a delithiated form of a lithium alloy.

In some of any of the embodiments described herein, the first and third layers comprise the same substance capable of reversibly releasing lithium (or delithiated form thereof). Such similar layers may be useful, for example, for forming a capacitor.

In some of any of the embodiments described herein, the first and third layer comprise different substances capable of reversibly releasing lithium (or delithiated form thereof), for example, wherein the substance capable of reversibly releasing lithium of one layer (which may arbitrarily be designated the first layer) is suitable for use in an anode and the substance capable of reversibly releasing lithium of the other layer (which may arbitrarily be designated the first layer) is suitable for use in a cathode. Such layers may be useful, for example, for forming a battery.

LTO (lithium titanate) and lithium alloys (and delithiated forms thereof) are non-limiting examples of substances suitable for use in an anode. LFP, LCO, LMO, NCA and NMC (and delithiated forms thereof) are non-limiting examples of substances suitable for use in a cathode.

Herein throughout, references to a “compound” are intended to encompass elements and mixtures of elements, unless explicitly indicated otherwise.

Herein, a compound “which forms an alloy” with lithium refers to a compound or element which exhibits the property of being capable of forming, or which forms, an alloy with lithium upon combination with lithium, as opposed, for example, to remaining in a separate phase from the lithium. Optionally, the alloy is characterized by a specific stoichiometric proportion of lithium atoms, e.g., according to any of the respective embodiments described herein. The skilled person will be readily capable of determining which compounds and elements form an alloy with lithium.

According to some embodiments of any one of the embodiments described herein, the compound which forms an alloy with lithium comprises (and optionally consists of) silicon, tin, antimony, germanium, lead, bismuth, magnesium, aluminum, and/or an alloy of any one or more of the aforementioned elements with any other element, including, for example, mixtures (e.g., alloys) of any two or more of the aforementioned elements). Silicon-nickel alloy is an example of a suitable silicon alloy. Antimony-manganese alloy is an example of a suitable antimony alloy. Tin-cobalt alloy is an example of a suitable tin alloy. Germanium-tin alloy is a suitable example of an alloy of two of the aforementioned elements.

In some embodiments of any one of the embodiments described herein, the lithium alloy may be described by the general formula LiₓA, wherein Li is lithium and A is an element which forms an alloy with lithium, for example, silicon, tin, antimony, germanium, lead, bismuth, and/or mixtures thereof. Examples of such alloys include, without limitation, alloys wherein A is silicon and x=4.2 (e.g., Li_{4.2}Si) or x=4.4 (e.g., Li_{4.4}Si), A is tin and x=4.4 (e.g., Li_{4.4}Sn), A is antimony and x=3 (e.g., Li₃Sb), A is germanium and x=4.4 (e.g., Li_{4.4}Ge), A is lead and x is about 0.2 (e.g., Li_{1.7}Pb₈₃), A is bismuth and x=3 (e.g., Li₃Bi), A is antimony-manganese and x is about 0.5 (e.g., Li_{32.2}Sb_{31.8}Mn₃₆), and wherein A is a germanium-tin alloy (e.g., Ge_{1-y}Sn_{y} wherein y=0.1-0.4).

It is expected that during the life of a patent maturing from this application many relevant substances capable of reversibly releasing lithium (e.g., lithium metal oxide/sulfides and lithium alloys) will be developed and the scope of the terms “substance capable of reversibly releasing lithium”, “lithium metal oxide/sulfide” and “lithium alloy” are intended to include all such respective new technologies a priori.

First and Third Layers:

The thermoplastic polymers of the first and third layers (the first and third thermoplastic polymer, respectively) may optionally be the same as one another and/or different; and each may be the same as the second thermoplastic polymer of different. In addition, each of the first and third thermoplastic polymer may optionally comprise a mixture (e.g., blend) of distinct types of polymer.

Examples of thermoplastic polymers (which may be used individually or in combination) suitable for use in any of the embodiments described herein relating to a first and/or third thermoplastic polymer include, without limitation, acrylonitrile butadiene styrene, polylactic acid, polyethylene terephthalate, polycarbonates, polyamides, polyurethanes, polystyrene, polyvinyl alcohol, polyvinylpyrrolidone, polyacrylic acid (or a salt thereof), polymethyl methacrylate, polyvinylidene fluoride, polyvinylidene chloride, polyethylene, polypropylene, polyethylene oxide, carboxymethylcellulose (or a salt thereof), lignin and rubber, including copolymers of two or more of any of the foregoing.

Further polymers which may optionally be included in the first and/or third thermoplastic polymer include, for example, polytetrafluoroethylene, polysulfones, polyimides, polyethylene imine (PEI), polyethers (e.g., polyphenylene oxide (PPO)), polybenzimidazole, and polyphenylene (PP), including copolymers thereof (e.g., poly(ethylenetetrafluoroethylene) (ETFE)).

The first and/or third thermoplastic polymer is optionally extrudable (as defined herein), that is, the polymer per se is extrudable.

In optional embodiments, the first thermoplastic polymer and/or third thermoplastic polymer is biodegradable, i.e., is broken down by the action of living organisms (e.g., bacteria). Polylactic acid is an exemplary thermoplastic polymer which is also biodegradable.

In some of any of the respective embodiments described herein, a concentration of first thermoplastic polymer in the first layer and/or a concentration of third thermoplastic polymer in the third layer is at least 20 weight percents (e.g., from 20 to 80 weight percents). In some embodiment, the concentration of thermoplastic polymer is at least 25 weight percents (e.g., from 25 to 75 weight percents). In some embodiment, the concentration of thermoplastic polymer is at least 30 weight percents (e.g., from 30 to 70 weight percents). In some embodiment, the concentration of thermoplastic polymer is at least 35 weight percents (e.g., from 35 to 65 weight percents). In some embodiment, the concentration of thermoplastic polymer is at least 40 weight percents (e.g., from 40 to 60 weight percents).

In some of any of the respective embodiments described herein relating to a thermoplastic polymer, the substance capable of reversibly releasing lithium (according to any of the respective embodiments described herein) is in a form of particles dispersed in the polymer.

In some of any of the respective embodiments, a first layer and/or third layer according to any of the respective embodiments described herein further comprises an electrically conductive substance, optionally in a form of conductive particles (e.g., particles dispersed in the polymer), which is capable of conducting electrons. The electrically conductive substance may comprise, for example, a metal and/or carbon. In exemplary embodiments the conductive substance comprises carbon particles.

Herein, the term “electrically conductive” refers to a substance capable of conducting electrons.

Examples of suitable carbon particles (e.g., powder) include, without limitation, graphite, graphene, carbon nanotubes (e.g., multi-walled carbon nanotubes, optionally functionalized with carboxylic acid groups) and amorphous carbon (e.g., carbon black). Graphite, carbon nanotubes and carbon black are exemplary forms of carbon particles suitable for inclusion in the first and/or third layer.

Without being bound by any particular theory, it is believed that an electrically conductive substance (e.g., conductive particles) incorporated into a first and/or third layer described herein can provide sufficient electron conductivity for efficient use in an electrode formed from the first and/or third layer. It is further believed that lithium ion conductivity of the first and/or third layer, due to ability of lithium ions to diffuse through the first and/or third thermoplastic polymer (e.g., due to porosity) and/or via ion conductivity of a substance capable of reversibly releasing lithium (or delithiated form thereof) and/or lithium salt (according to any of the respective embodiments described herein), interacts with electron conductivity to provide electric conductivity (via movement of both lithium ions and electrons).

The weight ratio of (total) electrically conductive substance (e.g., carbon) to (total) substance capable of reversibly releasing lithium (or delithiated form thereof) in a first and/or third layer (according to any of the respective embodiments described herein) is optionally within a range of from 10:1 to 1:10, optionally from 3:1 to 1:3, optionally from 2:1 to 1:2, and optionally from 1.5:1 to 1:1.5. In exemplary embodiments the weight ratio is about 1:1.

In some of any of the respective embodiments described herein, a total concentration of a substance capable of reversibly releasing lithium (and/or delithiated form thereof) in the first layer and/or third layer is at least about 5 weight percents. In some embodiments, a total concentration of a substance capable of reversibly releasing lithium (and/or delithiated form thereof) in the first layer and/or third layer is at least about 10 weight percents. In some embodiments, a total concentration of a substance capable of reversibly releasing lithium (and/or delithiated form thereof) in the first layer and/or third layer is at least about 20 weight percents. In some embodiments, a total concentration of a substance capable of reversibly releasing lithium (and/or delithiated form thereof) in the first layer and/or third layer is at least about 30 weight percents. In some embodiments, a total concentration of a substance capable of reversibly releasing lithium (and/or delithiated form thereof) in the first layer and/or third layer is at least about 40 weight percents. In some embodiments, a total concentration of a substance capable of reversibly releasing lithium (and/or delithiated form thereof) in the first layer and/or third layer is at least about 50 weight percents. In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the first layer and/or third layer is no more than about 80 weight percents. In some such embodiments, the total concentration is in a range of from about 5 to about 80 weight percents. In some embodiments, the total concentration is in a range of from about 10 to about 80 weight percents. In some embodiments, the total concentration is in a range of from about 20 to about 80 weight percents. In some embodiments, the total concentration is in a range of from about 30 to about 80 weight percents. In some embodiments, the total concentration is in a range of from about 40 to about 80 weight percents. In some embodiments, the total concentration is in a range of from about 50 to about 80 weight percents. In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the first layer and/or third layer is no more than about 70 weight percents. In some such embodiments, the total concentration is in a range of from about 5 to about 70 weight percents. In some embodiments, the total concentration is in a range of from about 10 to about 70 weight percents. In some embodiments, the total concentration is in a range of from about 20 to about 70 weight percents. In some embodiments, the total concentration is in a range of from about 30 to about 70 weight percents. In some embodiments, the total concentration is in a range of from about 40 to about 70 weight percents. In some embodiments, the total concentration is in a range of from about 50 to about 70 weight percents. In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the first layer and/or third layer is no more than about 60 weight percents. In some such embodiments, the total concentration is in a range of from about 5 to about 60 weight percents. In some embodiments, the total concentration is in a range of from about 10 to about 60 weight percents. In some embodiments, the total concentration is in a range of from about 20 to about 60 weight percents. In some embodiments, the total concentration is in a range of from about 30 to about 60 weight percents. In some embodiments, the total concentration is in a range of from about 40 to about 60 weight percents. In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the first layer and/or third layer is no more than about 50 weight percents. In some such embodiments, the total concentration is in a range of from about 5 to about 50 weight percents. In some embodiments, the total concentration is in a range of from about 10 to about 50 weight percents. In some embodiments, the total concentration is in a range of from about 20 to about 50 weight percents. In some embodiments, the total concentration is in a range of from about 30 to about 50 weight percents. In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the first layer and/or third layer is no more than about 40 weight percents. In some such embodiments, the total concentration is in a range of from about 5 to about 40 weight percents. In some embodiments, the total concentration is in a range of from about 10 to about 40 weight percents. In some embodiments, the total concentration is in a range of from about 20 to about 40 weight percents. In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the first layer and/or third layer is no more than about 30 weight percents. In some such embodiments, the total concentration is in a range of from about 5 to about 30 weight percents. In some embodiments, the total concentration is in a range of from about 10 to about 30 weight percents. In some of any of the aforementioned embodiments, the substance capable of reversibly releasing lithium is a lithium metal oxide/sulfide according to any of the respective embodiments described herein.

In some of any of the respective embodiments described herein, a concentration of first thermoplastic polymer in a first layer and/or third thermoplastic in a third layer (according to any of the respective embodiments described herein) is no more than 60 weight percents, for example, from 20 to 60 weight percents, or from 25 to 60 weight percents, or from 30 to 60 weight percents, or from 35 to 60 weight percents, or from 40 to 60 weight percents. In some such embodiments, a concentration of a substance capable of reversibly releasing lithium is at least 20 weight percents (e.g., from 20 to 80 weight percents, or from 20 to 70 weight percents), according to any of the respective embodiments described herein. In some embodiments, a concentration of a substance capable of reversibly releasing lithium is at least 30 weight percents (e.g., from 30 to 80 weight percents, or from 30 to 70 weight percents), according to any of the respective embodiments described herein. In some embodiments, a concentration of a substance capable of reversibly releasing lithium is at least 40 weight percents (e.g., from 40 to 80 weight percents, or from 40 to 70 weight percents), according to any of the respective embodiments described herein.

In some of any of the respective embodiments described herein, a first thermoplastic polymer in a first layer and/or third thermoplastic in a third layer (according to any of the respective embodiments described herein) is no more than 50 weight percents, for example, from 20 to 50 weight percents, or from 25 to 50 weight percents, or from 30 to 50 weight percents, or from 35 to 50 weight percents, or from 40 to 50 weight percents. In some such embodiments, a concentration of a substance capable of reversibly releasing lithium is at least 30 weight percents (e.g., from 30 to 80 weight percents, or from 30 to 70 weight percents), according to any of the respective embodiments described herein. In some embodiments, a concentration of a substance capable of reversibly releasing lithium is at least 40 weight percents (e.g., from 40 to 80 weight percents, or from 40 to 70 weight percents), according to any of the respective embodiments described herein. In some embodiments, a concentration of a substance capable of reversibly releasing lithium is at least 50 weight percents (e.g., from 50 to 80 weight percents, or from 50 to 70 weight percents), according to any of the respective embodiments described herein.

In some of any of the respective embodiments described herein, a first thermoplastic polymer in a first layer and/or third thermoplastic in a third layer (according to any of the respective embodiments described herein) is no more than 40 weight percents, for example, from 20 to 40 weight percents, or from 25 to 40 weight percents, or from 30 to 40 weight percents. In some such embodiments, a concentration of a substance capable of reversibly releasing lithium is at least 40 weight percents (e.g., from 40 to 80 weight percents, or from 40 to 70 weight percents), according to any of the respective embodiments described herein. In some embodiments, a concentration of a substance capable of reversibly releasing lithium is at least 50 weight percents (e.g., from 50 to 80 weight percents, or from 50 to 70 weight percents), according to any of the respective embodiments described herein. In some embodiments, a concentration of a substance capable of reversibly releasing lithium is at least 60 weight percents (e.g., from 60 to 80 weight percents), according to any of the respective embodiments described herein.

In some of any of the respective embodiments described herein, a first thermoplastic polymer in a first layer and/or third thermoplastic in a third layer (according to any of the respective embodiments described herein) is no more than 30 weight percents, for example, from 20 to 30 weight percents. In some such embodiments, a concentration of a substance capable of reversibly releasing lithium is at least 50 weight percents (e.g., from 50 to 80 weight percents, or from 50 to 70 weight percents), according to any of the respective embodiments described herein. In some embodiments, a concentration of a substance capable of reversibly releasing lithium is at least 60 weight percents (e.g., from 60 to 80 weight percents, or from 60 to 70 weight percents), according to any of the respective embodiments described herein. In some embodiments, a concentration of a substance capable of reversibly releasing lithium is at least 70 weight percents (e.g., from 70 to 80 weight percents), according to any of the respective embodiments described herein.

In some of any of embodiments described herein, the first layer and/or third layer further comprises at least one compound comprising lithium ions (e.g., lithium salt), optionally a lithium ion-containing compound according to any of the embodiments described herein in the section regarding the second layer. The lithium ion-containing compound according to any of the respective embodiments may optionally enhance lithium ion conductivity of the first and/or third layer, e.g., facilitating its use as an electrode.

In some of any of respective embodiments described herein, a total concentration of the (one or more) lithium ion-containing compound (e.g., lithium salt) in the first layer and/or third layer is at least about 2 weight percents. In some embodiments, a total concentration of lithium ion-containing compound (e.g., lithium salt) in the second layer is at least about 5 weight percents. In some embodiments, a total concentration of lithium ion-containing compound (e.g., lithium salt) in the second layer is at least about 10 weight percents. In some embodiments, a total concentration of lithium ion-containing compound (e.g., lithium salt) in the second layer is at least about 20 weight percents.

In some of any of the respective embodiments described herein, a total concentration of lithium ion-containing compound (e.g., lithium salt) in the first layer and/or third layer is no more than about 30 weight percents. In some such embodiments, the total concentration is in a range of from about 2 to about 30 weight percents. In some embodiments, the total concentration is in a range of from about 5 to about 30 weight percents. In some embodiments, the total concentration is in a range of from about 10 to about 30 weight percents. In some embodiments, the total concentration is in a range of from about 20 to about 30 weight percents.

In some of any of the respective embodiments described herein, a total concentration of lithium ion-containing compound (e.g., lithium salt) in the first layer and/or third layer is no more than about 20 weight percents. In some such embodiments, the total concentration is in a range of from about 2 to about 20 weight percents. In some embodiments, the total concentration is in a range of from about 5 to about 20 weight percents. In some embodiments, the total concentration is in a range of from about 10 to about 20 weight percents.

In some of any of the respective embodiments described herein, a total concentration of lithium ion-containing compound (e.g., lithium salt) in the first layer and/or third layer is no more than about 10 weight percents. In some such embodiments, the total concentration is in a range of from about 2 to about 10 weight percents. In some embodiments, the total concentration is in a range of from about 5 to about 10 weight percents.

In some of any of the respective embodiments described herein, first layer, second layer and/or third layer according to any of the respective embodiments described herein further comprises a plasticizer, e.g., in admixture with a first thermoplastic polymer, second thermoplastic polymer, or third thermoplastic polymer, respectively (according to any of the respective embodiments described herein).

Herein, the term “plasticizer” refers to any additive which increases the plasticity and/or decreases the viscosity of a composition comprising a thermoplastic polymer, e.g., by modulating the plasticity and/or viscosity of the polymer.

Examples of plasticizers include, without limitation, esters (e.g., C₁-C₁₀-alkyl esters) of aromatic or aliphatic dicarboxylic acids and tricarboxylic acids, such as phthalates (e.g., bis(2-ethylhexyl) phthalate, bis(2-propylheptyl) phthalate, diisononyl phthalate, di-n-butyl phthalate, butyl benzyl phthalate, diisodecyl phthalate, dioctyl phthalate, diisooctyl phthalate, diethyl phthalate), terephthalates (e.g., dioctyl terephthalate), trimellilates (e.g., trimethyl trimellilate, tri-(2-ethylhexyl) trimellilate), tri-(n-heptyl) trimellilate, tri-(n-octyl) trimellilate, tri-(n-nonyl) trimellilate, tri-(n-decyl) trimellilate), adipates (e.g., dimethyl adipate, monomethyl adipate, dioctyl adipate, bis(2-ethylhexyl) adipate), sebacates (e.g., dibutyl sebacate), azelates, maleates (e.g., dibutyl maleate, diisobutyl maleate), citrates (e.g., trimethyl citrate, triethyl citrate, acetyl triethyl citrate, tributyl citrate, acetyl tributyl citrate, trihexyl citrate, acetyl trihexyl citrate, butyryl trihexyl citrate, trioctyl citrate, acetyl trioctyl citrate) and 1,2-cyclohexane dicarboxylic acid (e.g., 1,2-cyclohexane dicarboxylic acid diisononyl ester); carbonate esters (e.g., propylene carbonate, ethylene carbonate); benzoates; sulfonamides, such as aryl sulfonamides (e.g., N-ethyl toluene sulfonamide, N-(2-hydroxypropyl) benzene sulfonamide, N-(n-butyl) benzene sulfonamides); organophosphate esters (e.g., tricresyl phosphate, tributyl phosphate); glycerol and glycols and esters thereof (e.g., triacetin, triethylene glycol dihexanoate, triethylene glycol diheptanoate); and polyethers (e.g., polyethylene glycol).

Polyethylene glycol (PEG) (e.g., low-molecular weight polyethylene glycol) is a non-limiting example of a suitable plasticizer (e.g., for use in combination with polylactic acid). Low-molecular weight polyethylene glycol according to any of the respective embodiments described herein (e.g., for use as a plasticizer) optionally has an average molecular weight of about 3,000 Da or less (e.g., from about 250 to about 3,000 Da, or from about 500 Da to about 3,000 Da, or from about 1,000 to about 3,000 Da), and optionally about 2,000 Da or less (e.g., from about 250 to about 2,000 Da, or from about 500 Da to about 2,000 Da, or from about 1,000 Da to about 2,000 Da).

In some of any of the respective embodiments, a concentration of plasticizer in a layer comprising a thermoplastic polymer (e.g., first and/or third layer) according to any of the respective embodiments described herein is at least 0.1 weight percent, for example from 0.1 to 10 weight percent, or from 0.1 to 3 weight percent. In some embodiments, a concentration of plasticizer is at least 0.3 weight percent, for example from 0.3 to 10 weight percent, or from 0.3 to 3 weight percent. In some embodiments, a concentration of plasticizer is at least 1 weight percent, for example from 1 to 10 weight percent, or from 1 to 3 weight percent.

Current Collector Layer:

As mentioned hereinabove, the composition-of-matter according to any of the embodiments described herein may optionally comprise at least one layer comprising a substance capable of serving as a current collector (which for convenience is also referred to herein as a “current collector layer”). Each such current collector layer is in contact with a first layer and/or third layer. In some such embodiments, the composition-of-matter comprises a current collector layer in contact with the first layer and another current collector layer in contact with the third layer, e.g., such that an order of the layers is current collector layer-first layer-second layer-third layer-current collector layer.

Herein throughout, a “current collector” refers to an electrically conductive material configured for mediating current (e.g., in the form of electrons) between various portions of an electrode and an electrical contact, optionally a single electrical contact).

For example, a current collector layer preferably has a high ratio of surface area in contact with an electrode to current collector layer volume, optionally be being in a form of a thin sheet or filament.

Alternatively or additionally, a current collector layer may have a branched structure in the vicinity of an electrode, reaching over a considerable area of an electrode (while occupying only a fraction of the volume adjacent to the electrode) connected to a centralized structure (e.g., a single wire) in the vicinity of an electrical contact.

The substance capable of serving as a current collector may optionally be any electrically conductive substance, and is optionally thermoplastic. Such a substance may be, for example, a metal (e.g., a metal with a low melting point for facilitating dispensation by heating), carbon, and/or or a combination of a thermoplastic polymer and an electrically conductive substance, optionally in a form of conductive particles (e.g., particles dispersed in the polymer).

The substance capable of serving as a current collector of two different current collector layers (if present) may optionally be the same as one another and/or different.

A thermoplastic polymer of a current collector layer (optionally in combination with a plasticizer) may optionally be a thermoplastic polymer according to any of the respective embodiments described herein with respect to a first thermoplastic polymer, a second thermoplastic polymer and/or a third thermoplastic polymer; and/or in a concentration (within the current collector layer) according to any of the respective embodiments described herein with respect to a first thermoplastic polymer, a second thermoplastic polymer and/or a third thermoplastic polymer.

An electrically conductive substance may comprise, for example, a metal and/or carbon.

Examples of suitable carbon particles (e.g., powder) include, without limitation, graphite, graphene, carbon nanotubes (e.g., multi-walled carbon nanotubes, optionally functionalized with carboxylic acid groups) and amorphous carbon (e.g., carbon black).

In some of any of the respective embodiments described herein, a total concentration of electrically conductive substance in one or more current collector layer is at least about 20 weight percents. In some embodiments, a total concentration of electrically conductive substance is at least about 30 weight percents. In some embodiments, a total concentration of electrically conductive substance is at least about 40 weight percents. In some embodiments, a total concentration of electrically conductive substance is at least about 50 weight percents. In some embodiments, a total concentration of electrically conductive substance is at least about 60 weight percents. In some embodiments, a total concentration of electrically conductive substance is at least about 70 weight percents. In some embodiments, a total concentration of electrically conductive substance is at least about 80 weight percents.

In some of any of the respective embodiments described herein, a total concentration of electrically conductive substance and thermoplastic polymer in one or more current collector layer is at least about 90 weight percents. In some embodiments, a total concentration of electrically conductive substance and thermoplastic polymer is at least about 95 weight percents. In some embodiments, a total concentration of electrically conductive substance and thermoplastic polymer is at least about 98 weight percents. In some embodiments, a total concentration of electrically conductive substance and thermoplastic polymer is at least about 99 weight percents.

Method of Preparation:

According to an aspect of some embodiments of the invention, there is provided a method of preparing a composition-of-matter according to any of the embodiments described herein. In some embodiments, the method comprises dispensing the first layer, second layer and third layer, optionally concomitantly. In some embodiments, the method further comprises dispensing (optionally concomitantly with the first layer, second layer and third layer) at least one layer comprising a substance capable of serving as a current collector (e.g., according to any of the embodiments described herein relating to such a layer).

Dispensing optionally comprises heating one or more compositions for forming the respective layers, to thereby provide a dispensable form of each composition (e.g., a heated composition featuring rheological properties suitable for being dispensed through a nozzle) and dispensing (e.g., concomitantly) the dispensable, heated composition(s), optionally using any suitable technique known in the art. The heating of the composition(s) is optionally to a temperature that allows fusion of at least some of the layers to one another.

In some of any of the embodiments described herein, the heating of the composition(s) is to a temperature of at least about 100° C., at least about 150° C., at least about 170° C., or at least about 180° C. 175-180° C. is an exemplary temperature range (e.g., for forming a layer comprising polylactic acid, optionally in combination with polyethylene oxide).

In some of any of the embodiments described herein, the heating of the composition(s) is to a temperature of no more than about 300° C., no more than about 250° C., no more than about 225° C., or no more than about 210° C.

In any of the respective embodiments described herein, the dispensing is by one or more extruders. An extruder optionally comprises a “cold end” configured for receiving one or more composition prior to heating (optionally a filament from a spool), a mechanism (e.g., roller or screw) for moving the received composition(s) through the extruder, a mechanism for heating the composition(s) (e.g., a heating chamber), and a nozzle through which the heated composition(s) is extruded, the nozzle optionally being configured to one or more compositions, e.g., in a form of sheets or filaments.

In some embodiments, each type of layer is dispensed from a different dispensing head and/or nozzle, optionally concomitantly.

In some embodiments, multiple types of layers (optionally all of the layers) are dispensed from a single dispensing head and/or nozzle configured for co-extruding (i.e., concomitantly extruding) different types of composition (e.g., as exemplified in the Examples section herein).

Extrusion may optionally be a relatively simple process, for example, wherein a composition-of-matter with a constant cross section is produced (e.g., in a single step).

Alternatively, extrusion may be a more complex (e.g., multi-step) process, for example, involving additive manufacturing to produce a composition-of-matter with a configured pattern (e.g., a pre-determined configured pattern corresponding to a desired shape of an electrochemical system), optionally to produce a complex pattern which is difficult to obtain by a simpler extrusion process.

Additive manufacturing is generally a process in which a three-dimensional (3D) object is manufactured utilizing a computer model of the objects. The basic operation of any additive manufacturing system typically consists of slicing a three-dimensional computer model into thin cross sections, translating the result into two-dimensional position data and feeding the data to control equipment which manufacture a three-dimensional structure in a layer-wise manner.

Various additive manufacturing technologies exist, amongst which are stereolithography, digital light processing (DLP), and three-dimensional (3D) printing. Such techniques are generally performed by layer by layer deposition and solidification of one or more building materials.

In 3D printing processes, for example, a building material is typically dispensed from a printing head having a set of nozzles to deposit layers on a supporting structure. Depending on the building material, the layers may then solidify, harden or be cure, optionally using a suitable device.

Extrusion-based 3D printing may employ a three-axis motion stage to draw patterns by robotically depositing material (e.g., squeezing “ink” through a micro-nozzle). This technique can be divided into droplet-based approaches (e.g., ink-jet printing and hot-melt printing) and filamentary-based approaches (e.g., robocasting and fused filament fabrication), based on the rheological properties of the ink materials (see for example, [Zhang et al., Nano Energy 2017, 40:418-431]).

Electrochemical System:

According to an aspect of some embodiments of the invention, there is provided an electrochemical system comprising a composition-of-matter described herein, according to any of the respective embodiments.

According to an aspect of some embodiments of the invention, there is provided a method of manufacturing an electrochemical system described herein, according to any of the respective embodiments. The method according to this aspect comprises dispensing a composition-of-matter described herein, according to any of the respective embodiments, for example, using an extruder.

Dispensing is optionally performed as described herein (according to any of the respective embodiments) with respect to a method of preparing a composition-of-matter, optionally by co-extruding at least a portion of the layers (e.g., the first layer, second layer and third layer). In this manner, an electrochemical system which comprises at least two lithium-based electrodes and optionally at least one current collector may be obtained.

Alternatively, dispensing optionally comprises heating a composition-of-matter described herein (e.g., a composition-of-matter used as a feedstock), optionally a composition-of-matter in a form of filament, to thereby provide a dispensable form of the composition-of-matter, optionally using any suitable means and/or technique (e.g., fused filament fabrication) known in the art. In such embodiments, dispensing may allow for converting a simply shaped feedstock (e.g., a standardized feedstock) into a controlled (optionally complex) shape, for example, a shape suitable for a particular electrochemical system.

According to an aspect of some embodiments of the invention, there is provided an electrochemical system manufactured according to the method described herein, according to any of the respective embodiments.

Herein, the term “electrochemical system” encompasses systems having a functionality associated with an electrochemical reaction (e.g., transfer of lithium ions and/or electrons) as well as systems which exhibit such a functionality only upon some pre-treatment, for example, addition of a current collector and/or other electronic circuitry component.

In any of the embodiments described herein relating to an electrochemical system (according to any of the aspects described herein), the electrochemical system preferably comprises a lithium-based electrode formed from the first layer and/or third layer (according to any of the respective embodiments described herein), and more preferably comprises both a lithium-based electrode formed from the first layer and a lithium-based electrode formed from the third layer. In some embodiments, the first layer and/or third layer is in contact with a current collector layer (according to any of the respective embodiments described herein).

In any of the embodiments described herein relating to an electrochemical system (according to any of the aspects described herein), the electrochemical system preferably comprises a solid electrolyte formed from the second layer (according to any of the respective embodiments described herein) between two lithium-based electrodes, such as a first layer and third layer according to any of the respective embodiments described herein.

According to an aspect of some embodiments of the invention, there is provided a battery (e.g., a rechargeable battery) comprising at least one electrochemical system (and optionally a plurality of electrochemical systems) according to any of the respective embodiments described herein, for example, an electrochemical system wherein the first layer and the third layer of the composition-of-matter comprise different substances capable of reversibly releasing lithium (or delithiated form(s) thereof), according to any of the respective embodiments described herein.

Herein, the phrase “lithium ion battery” encompasses any source of electrical power which comprises one or more electrochemical cells, in which electrical power generation is associated with transfer of lithium ions from one electrode to another.

In some of any of the embodiments relating to a battery, the substance capable of reversibly releasing lithium in an anode of the battery (e.g., in a first layer of the composition-of-matter) is lithium titanate (LTO) and/or a lithium alloy, according to any of the respective embodiments described herein.

In some of any of the embodiments relating to a battery, the substance capable of reversibly releasing lithium in a cathode of the battery (e.g., in a third layer of the composition-of-matter) is a lithium metal oxide/sulfide, according to any of the respective embodiments described herein.

According to an aspect of some embodiments of the invention, there is provided a capacitor (e.g., supercapacitor) comprising at least one electrochemical system according to any of the respective embodiments described herein, for example, an electrochemical system wherein the first layer and the third layer of the composition-of-matter comprise the same substance capable of reversibly releasing lithium (or delithiated form thereof), according to any of the respective embodiments described herein. In some embodiments, the electrodes of the capacitor comprise the same substance but differ in the amount of lithium therein, that is, in the degree of lithiation.

Herein, the phrase “capacitor” refers to a device configured for storing electrical energy in an electric field.

Herein, the phrase “supercapacitor” refers to a capacitor in which energy is stored as electrostatic double-layer capacitance (e.g., in which a double layer—parallel charged layers—is formed at an interface between a surface of an electrode and an electrolyte) and/or as electrical pseudocapacitance (e.g., wherein energy is stored by charge transfer between electrode and electrolyte, by electrosorption, intercalation, oxidation and/or reduction reactions). In general, capacitors utilizing lithium ions for charge transfer (according to any of the respective embodiments described herein) are typically recognized in the art as supercapacitors.

Batteries and capacitors according to any of the respective embodiments described herein may optionally be mechanically flexible and/or of variable size or shape, including non-standard free form sizes and shapes, optionally designed for direct integration into and/or co-fabricated within, an electric device or component thereof, for example, electronic circuitry of a device.

The use of thermoplastic polymers in the various layers of the composition-of-matter (which correspond to electrodes and solid electrolyte, and optionally one or more current collector, of an electrochemical system), as described herein, allows co-fabrication (e.g., by co-extrusion) of different components of an electrochemical system in various complex configurations, while maintaining contact between the components over a large area, optionally with substantially no gaps between the respective components.

For example, at least one electrode optionally interlocks with the solid electrolyte and/or current collector in contact with the electrode. Such interlocking may optionally be obtained for example, by twisting a flexible composition-of-matter described herein (e.g., a film or filament) and/or by forming a composition-of-matter described herein in a twisted or otherwise complex shape (e.g., by extrusion using a suitable nozzle and/or by shaping a filament described herein in a desired shape).

Herein, two objects (e.g., electrode and current collector) are considered to “interlock” with one another when there exists at least one plane in which the shapes of the object are geometrically capable (i.e., in the absence of deformation) of being separated or sliding past one another by movement in no more than one direction in said plane, and optionally not at all (i.e., in zero directions in said plane). Optionally, the interlocked objects are geometrically incapable (i.e., in the absence of deformation) of being separated or sliding past one by movement in any direction (in any plane).

Microbatteries or various free-form-factor electrochemical systems with interweaving core-shell electrodes (e.g., as described in Ragones et al. [Sustainable Energy Fuels 2018, 2:1542-1549]) may be prepared.

Small-scale electrochemical systems (e.g., microbatteries) are particularly suitable for electrochemical systems comprising a solid electrolyte, as the relatively low conductivity (in comparison to liquid electrolytes) is less problematic when the electrolyte layer is very thin. In this context, the methods and compositions-of-matter described herein help to overcome the non-trivial obstacle of how cast very thin solid electrolytes onto complex electrode structures.

The demand for multifunctional portable/wearable electronic devices, including wireless sensors and implantable medical devices is continuously growing. Such devices frequently need rechargeable energy sources with dimensions on the scale of about 1-10 mm³. Electrochemical systems and methods described herein may optionally be used to satisfy such dimensional requirements, while also providing good performance (e.g., due to a high electrode/electrolyte interfacial area).

As used herein the term “about” refers to ±20%. In some embodiments of any of the respective embodiments, the term “about” refers to ±10

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

Materials:

Al₂O₃ was obtained from Nanografi Co. Ltd.

C65 carbon (C-NERGY™ SUPER C65) was obtained from TIMCAL.

Graphite powder was obtained from SkySpring Nanomaterials, Inc.

Graphitized multiwalled (—COOH)— functionalized carbon nanotubes were obtained from US Research Nanomaterials, Inc.

LiFePO₄ (LFP) powder (Life Power® P2) was obtained from Clariant.

Lithium TFSI (lithium bis(trifluoromethane)sulfonimide, a.k.a. lithium bistriflimide) was obtained from Solvionic.

Lithium titanate (Li₄Ti₅O₁₂, LTO) was obtained from Sud-Chemie Clariant.

PEO (polyethylene oxide, 5*10⁶ Da) was obtained from Sigma-Aldrich.

PLA (polylactic acid) pellets (Purac® PLA L-175) were obtained from Corbion.

SiO₂ was obtained from Sigma-Aldrich.

Preparation of Polymeric Materials for 3D Printing:

Two solid polymer electrolytes containing PLA (polylactic acid), PEO (polyethylene oxide) and LiTFSI (lithium bis(trifluoromethane)sulfonimide) with SiO₂ or Al₂O₃ ceramic fillers were fabricated according to the following concentrations (59:20:20:1% w/w). PLA pellets were dissolved in 1,3-dioxolane under stirring for 12 hours at room temperature. LiTFSI, PEO and ceramic powders—SiO₂ (7 nm) or Al₂O₃ (4 nm)—were dispersed in acetonitrile under stirring for 12 hours. Both solutions (PLA & PEO solutions) were mixed with the use of an ARE-250 mixer (Thinky) at 1500 rpm for 15 minutes. After complete dissolution, the resulting homogeneous mixture was poured on a polytetrafluoroethylene plate and dried for 12 hours at room temperature. After drying, each cast was crushed to small pellets to be used for the fabrication of filaments. Each composite was extruded with an Evo™ filament extruder (Felfil, Italy) to form a filament suitable for use as feedstock in a fused-deposition 3D printer. With appropriate choice of the nozzle diameter (in the range of 1.4-1.7 mm) and careful control of the nozzle temperature (e.g., in the range 175-180° C.) and the extrusion speed, filaments were produced with a circular cross section of average diameter 1.75 mm and a typical standard deviation of 0.02-0.03 mm. Each filament was printed with the use of an UP Plus 2 3D printer (Tiertime).

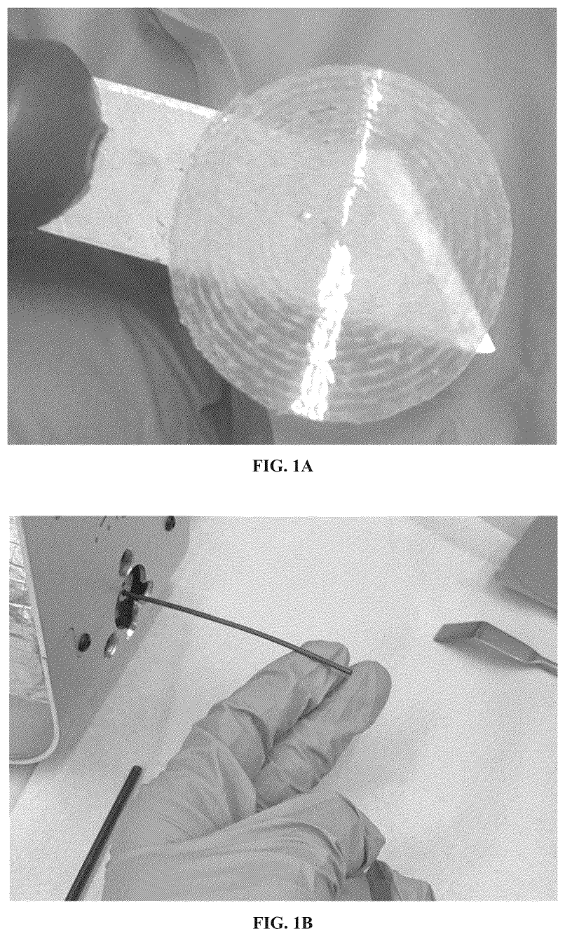

For the preparation of cathodes, LiFePO₄ (LFP) powder as active cathode material, graphite powder, graphitized multiwalled (—COOH)—functionalized carbon nanotubes and C65 carbon were dispersed in a ratio of 25:15:5:5% (w/w), respectively, with the use of a mixer (Thinky) as described above. The slurry was cast, dried and crushed. LFP/PLA/carbon composites were extruded with a Pro™ filament extruder (Nortek) to form a filament suitable for use as feedstock in a fused-deposition 3D printer (as shown in FIG. 1B).

Lithium titanate (LTO) was used as an active material for the fabrication of anode filaments. The LTO-to-carbon and LTO-to-PLA ratios were the same as in the cathode. Printed-disc electrodes with a diameter of 15 mm were used as cathodes. The fabrication process of the anode was similar to that of the cathode. The printed samples were dried under vacuum at 100° C. for 12 hours in order to remove residual solvent and moisture.

Conductivity Evaluation:

Cells comprising the 3D-printed polymer, sandwiched between two non-blocking lithium electrodes, were fabricated in coin cells (type 2032). All handling of these materials (including extrusion & printing) took place under an argon atmosphere in a glove box (MBRAUN) containing less than 10 ppm water and oxygen. Electrochemical impedance spectroscopy was used to test the conductivity of the composite electrolyte. Tests were carried out at 30 to 100° C. with a VMP3 potentiostat (BioLogic Instruments) at a setting of 100 mV amplitude and a frequency range of 1 MHz to 0.01 Hz.

Differential Scanning Calorimetry (DSC):

Differential scanning calorimetry (DSC) was carried out with a research-grade Q2000 MDSC® (Modulated DSC®) apparatus and Tzero® cell module (TA Instruments). Samples weighing 5 to 15 mg were sealed in Al pans in the glovebox and thermal runs were recorded at a heating/cooling ramp of 10° C./minute from room temperature up to 250° C., cooling to 30° C. and then heating to 250° C. As the thermal history of the materials is typically distorted at the first run, the DSC data of the second heating of the samples was analyzed and reported. The percentage of crystallinity of each polymer (X_{c}) was calculated as

$${X}_{C} = \frac{Δ {H}_{m} - Δ {H}_{CC}}{w \cdot Δ {H}_{100}} \cdot 100$$

where ΔHₘ is the value of melting enthalpy, and ΔH_{cc} is the cold-crystallization enthalpy, ΔH₁₀₀ is the enthalpy of the completely crystalline polymer, and w is the weight fraction of polymer in the sample. The values of ΔH₁₀₀ for PLA and PEO were 93.6 [Li et al., Polym Adv Technol 2015, 26:465-475] and 196.0 J/g [Zardalidis et al., Soft Matter 2016, 12:8124-8134], respectively.

Electron Microscopy:

Surface morphology was determined with a Quanta™ 200 FEG environmental scanning electron microscope (ESEM™) (JEOL Co.), equipped with an electron backscatter diffraction (HKL) and energy dispersive spectroscopy (Oxford Instruments) integrated analytical system. Samples were sputtered with a thin gold film (6-10 nm) prior to scanning.

Mass Spectroscopy:

TOF-SIMS (time of flight-secondary ion mass spectroscopy) measurements were performed with the use of a TRIFT™ II instrument (Physical Electronics Inc., USA), using Cs⁺ primary ions and beam diameter of 1 μm.

### Example 1

### Preparation and Characterization of Materials for Extrusion-Type Battery

In a thin, flexible battery, the electrochemical redox reactions occur across the width of the battery. Therefore, in order to evaluate the transverse ion transport, solid electrolytes were printed in a disc-like shape and assembled in a symmetrical Li/Li coin-cell setup. Two compositions of solid electrolytes containing PLA, PEO, LiTFSI and 1% silica or alumina were tested.

Compositions were used to print a disc-shaped solid electrolyte sample with a diameter of 19 mm and a thickness of 200 μm, as shown in FIG. 1A, using procedures described in the Materials and Methods section hereinabove.

Environmental scanning electron microscopy was used to investigate the surface morphologies of the specimens.

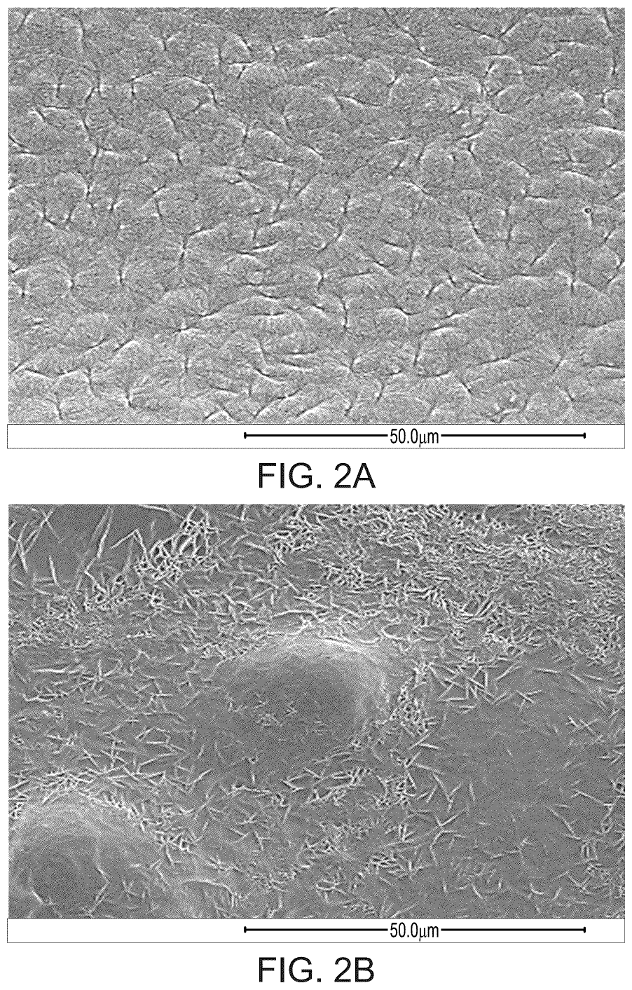

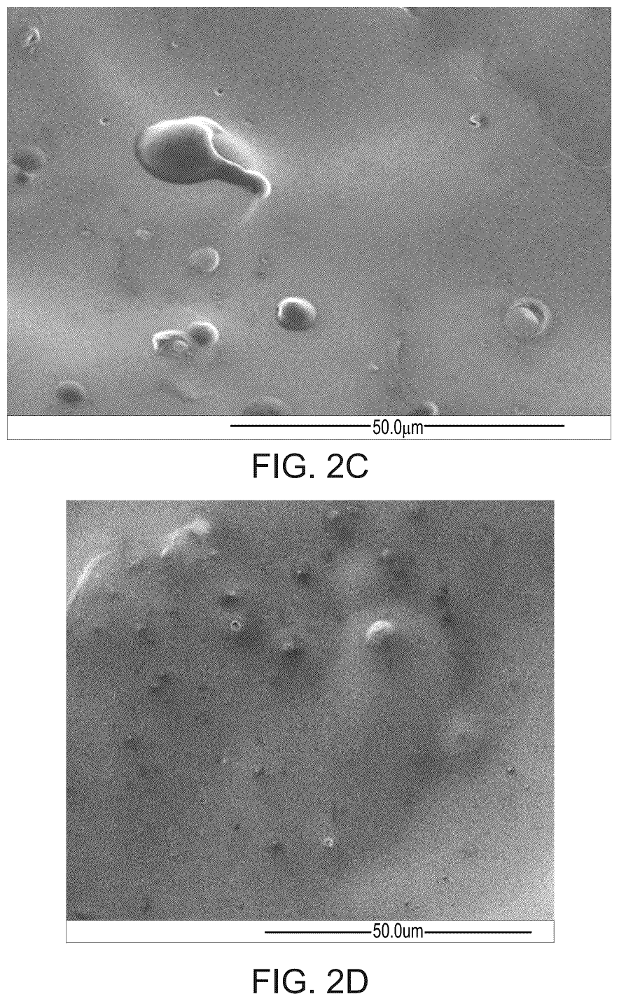

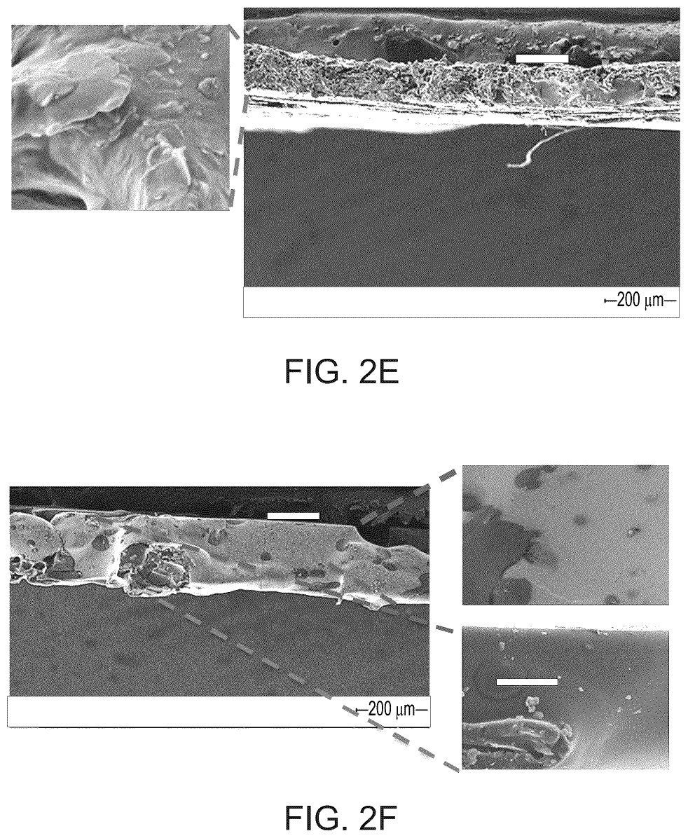

As shown in FIGS. 2A and 2B, readily distinguishable closely packed spherulites were observed in a printed neat PLA sample (FIG. 2A); whereas blending of PLA with PEO destroyed spherulitic morphology, and a needle-like structure with some flat surface inclusions was formed instead (FIG. 2B).

Without being bound by any particular theory, it is believed that the observed morphology is attributed to the PLA being plasticized by PEO entities in a continuous PLA phase, in agreement with Zare & Rhee [Compos Part B Eng 2019, 175:107132].

As can be seen from the top-surface environmental scanning electron microscopy views, both composite electrolytes do not exhibit phase separation morphology.

However, as shown in FIGS. 2C and 2D, EDS analysis of the cross-section of the electrolyte containing alumina revealed dark regions enriched by fluorine, which comes from the lithium imide salt.

As shown in FIGS. 2E and 2F, the thickness of the printed electrolytes was 102 to 108 μm for silica-containing electrolytes (FIG. 2E) and 210 to 220 μm for alumina-containing electrolytes (FIG. 2F).

In order to simulate the influence of extrusion and printing on the phase transitions occurring in polymers and solid electrolyte, differential scanning calorimetry (DSC) was used, according to procedures described hereinabove. The melting temperature (Tm), enthalpy of melting (ΔHₘ) and the degree of crystallinity (X_{c}) of each polymer, as well as the peak temperature (T_{cc}) and enthalpy for cold crystallization (ΔH_{cc}) of PLA were determined, and are summarized in Table 1.

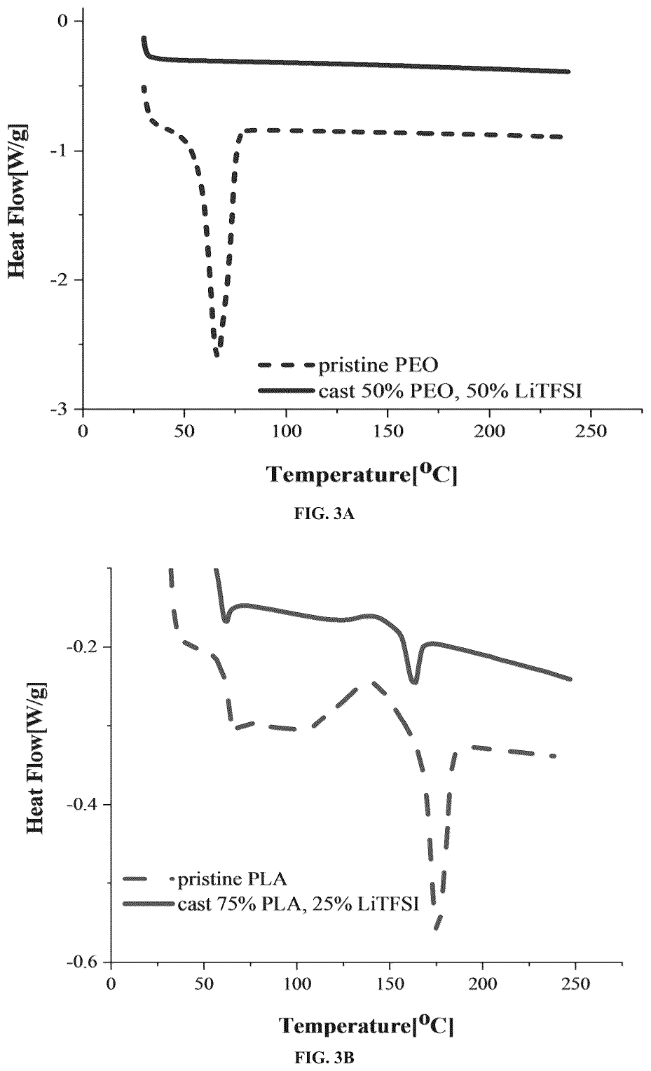

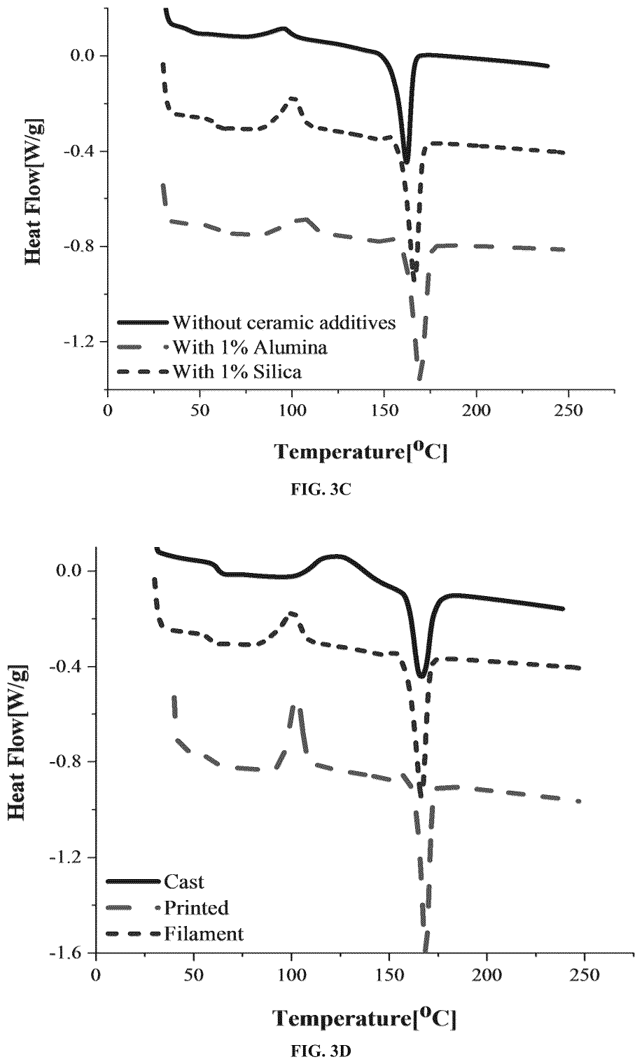

As shown in FIGS. 3A and 3B, the glass transition of PLA powder occurred at 63.8° C., followed by a broad, cold-crystallization exotherm at 113.7° C. and a sharp endothermic peak with the onset point of 168.6° C. (FIG. 3B); whereas the thermogram of PEO powder was characterized by a single melting peak at 59.6° C. (FIG. 3A).

TABLE 1
Melting temperature (Tm), enthalpy of melting (ΔHm), peak height and full width at
half maximum (FWHM), and crystallinity (Xc) of various substances comprising PLA and/or
PEO, and peak temperature (Tcc) and enthalpy (ΔHcc) of cold crystallization of PLA

| | Tg | Tcc | ΔHcc | Tm | ΔHm | FWHM | Height | Xc |
|---|---|---|---|---|---|---|---|---|
| | (° C.) | (° C.) | (J/g) | (° C.) | (J/g) | (° C.) | (W/g) | (%) |
| PEO powder | | | | 57.8 | 131.8 | 11.3 | 1.77 | 67.2 |
| PLA powder | 63.6 | 113.0 | 10.0 | 168.1 | 15.4 | 9.5 | 0.25 | 5.8 |
| PEO 40% + PLA 60% cast | | | | 53.9 | 35.0 | 7.9 | 0.6 | 46.5 |
| | | | | 158.1 | 27.4 | 8.0 | 0.48 | 48.7 |
| PEO + LiTFSI (20%) cast | All | Amorph | | | | | | |
| PLA + LiTFSI (20%) cast | 59.0 | 128.2 | 0.7 | 156.0 | 2.8 | 7.1 | 0.06 | 2.8 |
| PLA 60% + PEO40% + | 43.4 | 80.9 | 3.9 | 155.0 | 21.5 | 6.2 | 0.46 | 47 |
| LiTFSI filament | | | | | | | | |
| PLA 59% + PEO 20% + | 62.3 | 104.6 | 17.1 | 159.4 | 21.3 | 8.9 | 0.34 | 11.2 |
| LiTFSI + SiO₂ cast | | | | | | | | |
| PLA 59% + PEO 20% + | 58.7 | 88.5 | 9.9 | 159.7 | 25.3 | 6.3 | 0.59 | 41.0 |
| LiTFSI + SiO₂ filament | | | | | | | | |
| PLA 59% + PEO 20% + | 60.7 | 95.5 | 14.2 | 163.8 | 24.3 | 4.8 | 0.71 | 27.5 |
| LiTFSI + SiO₂ printed | | | | | | | | |
| PLA 59% + PEO 20% + | 60.3 | 86.4 | 7.3 | 162.3 | 27.8 | 7.3 | 0.57 | 54.6 |
| LiTFSI + Al₂O₃ filament | | | | | | | | |
| PLA 59% + PEO 20% + | 53.5 | 91.7 | 20.1 | 159.3 | 25.1 | 5.6 | 0.67 | 13.8 |
| LiTFSI + Al₂O₃ printed | | | | | | | | |

As shown in Table 1, the degree of crystallinity of the powders, calculated from the enthalpies of thermal transitions, was 5.8% and 67.2% for PLA and PEO, respectively.

These results indicate that PLA crystallized from melt, while being a semicrystalline material, has a more disordered structure than does PEO. This is consistent with the reported intrinsically low crystallization rate of PLA, which usually results in semicrystalline or amorphous structure under practical processing conditions [Zardalidis et al., Soft Matter 2016, 12:8124-8134; Saeidlou et al., Prog Polym Sci 2012, 37:1657-1677].

No significant changes appear in the second-heat thermogram of the extruded PLA filament, as compared to the powder. In addition, the cold crystallization peak of PLA was absent in the DSC trace of PLA-PEO cast sample. The glass transition of PLA coincides with the melting of PEO, and these were indistinguishable.

As further shown in Table 1, casting the PEO and PLA together reduced the crystallinity of the PEO, but increased the crystallinity of the PLA.

Incorporation of LiTFSI salt into the polymers at a concentration of about 20% (w/w) resulted in molar salt-to-polymer ratios of 1:6 or 1:10 for PEO and PLA systems.

As shown in FIGS. 3A and 3B, the LiTFSI suppressed crystallinity of PEO (FIG. 3A) and PLA (FIG. 3B) to a considerable extent.

These results suggest an interaction between the lithium salt and the polymers, which is consistent with a reduction of mechanical strength in both samples, making it difficult to print them.

As shown in Table 1 and in FIG. 3C, upon DSC analysis of a filament extruded from a PLA-PEO blend with LiTFSI, the melting peak of PEO was unavailable, the Tg of mixed-polymer electrolyte was shifted towards lower temperature by about 20° C. and appeared at 43.4° C. On the other hand, the enthalpy of the cold-crystallization peak was less than half that of neat PLA, and the value of ΔH increased from 15.4 to 21.5 J/g; and, taking into account the relative content of PLA, the calculated crystallinity of the PLA-PEO-LiTFSI filament was close to the ΔH of the sample without salt.

In addition, the printing process of the PLA-PEO-LiTFSI filament was possible, but complicated by its high ductility. This challenge was overcome by the addition of just one weight percent of silica or alumina nanoparticles.

As further shown in FIG. 3C, the ceramic (silica or alumina) additives have the effect of shifting the glass transition point and onset of melting to higher temperatures, as compared to the ceramic-free sample. In addition, the composition containing silica exhibits the lowest full width at half maximum (FWHM), indicating that it is the most ordered.

However, when the thermal data of composite electrolytes are compared with those of neat PLA, it is seen that both Tg and Tm are lower than those of the pristine polymer. This indicates increased mobility of PLA chains, caused by cooperative interaction with PEO, lithium salt and ceramics. The plasticizing efficiency of PEO was reported in Sungsanit et al. [Polym Eng Sc. 2012, 52:108-116] and Park et al. [J Appl Polym Sci 2012, 123:2360-2367].

Surprisingly, as shown in FIG. 3D and Table 1, printing of filaments lowered the degree of crystallinity of composite electrolytes, but induced order in the crystalline entities, as determined by analysis of the width and height of the melting peaks of the printed composite electrolytes and their filaments.

These results suggest that the printing process promotes the entrance of chains to crystalline lamellae and the formation of perfect crystals, which is reflected in the appearance of a strong, narrow melting peak. These results are consistent with those Ou & Cakmak [Polymer (Guildf) 2010, 51:783-792], who reported that constrained annealing of ordered PLA films led to an enhancement of structural order by increasing the crystal size, perfection and crystallinity.

TOF-SIMS was used to gain important information on the composition of printed electrolytes. Acquisition of a full raw-data stream (RDS) when recording spectra allowed for the construction of images representing the lateral distribution of PEO, PLA, lithium salt and ceramic additive in the samples. Neat PLA and PEO films were tested as reference samples. In order to confirm lithium salt interaction with polymers, mass spectra of PEO-LiTFSI and PLA-LiTFSI blends were acquired as well. The characteristic fragments of CH₃O⁺, C₂H₅O⁺, C₃H₄O⁺ and C₃H₄O₂⁺ were detected in the TOF-SIMS spectra of neat polymers. The molecular masses of the species are 31, 45, 56 and 72, respectively. These are associated with the (CH₂—CH₂O—) and [—O—CH(CH₃)—C(═O)—] repeating units of PEO and PLA. For the PLA-PEO samples, strong peaks of 46 and 56 mass unit fragments of both polymers were found. However, contrary to Ando et al. [Polym Degrad Stab 2013, 98:958-962], no additional high-molecular-mass peaks, such as 147, 157, 160 and 180, appear in the spectra. This indicates that formation of PLA-PEO-PLA and PEO-PLA-PEO block polymers on printing of free-of-salt polymer blends does not occur.

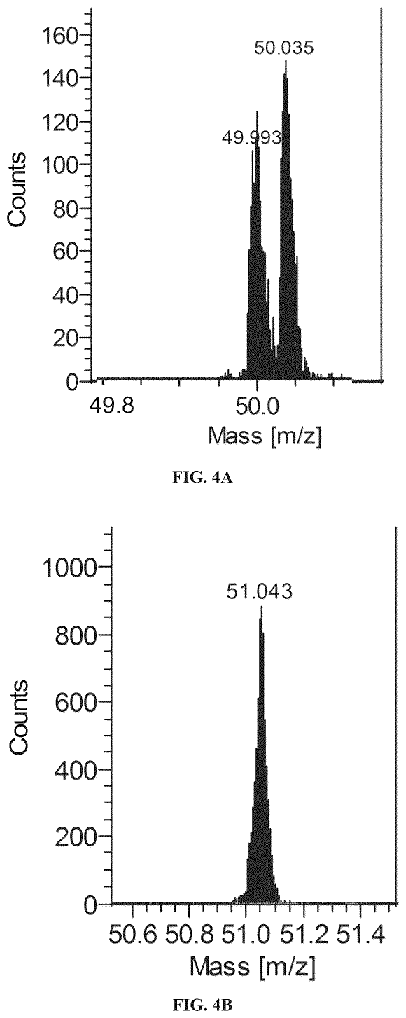

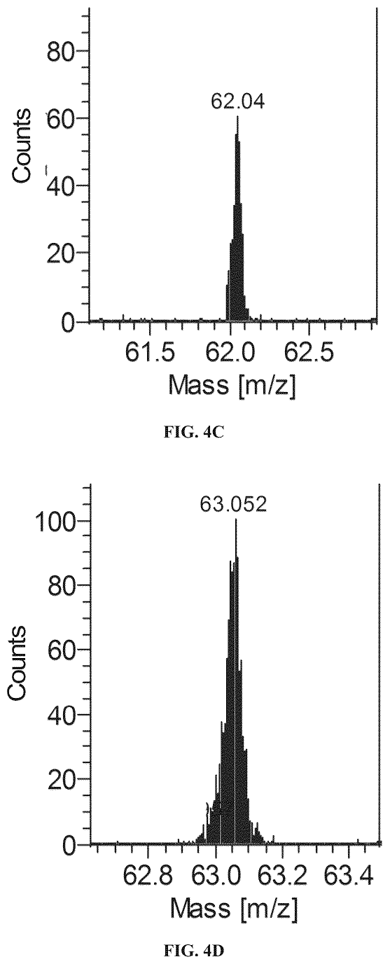

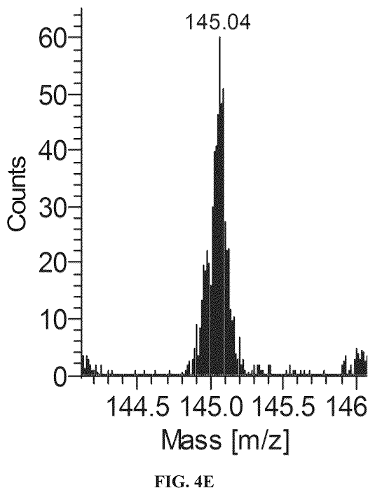

As shown in FIG. 4A, the TOF-SIMS spectrum of the PEO-LiTFSI was characterized by a strong 50 mass unit peak.

This result can be attributed to a PEO-Li complex, as it is well established that mixing of polyethylene oxide with lithium salts, either in solvents or on melting, results in dissociation of the salt and formation of ion-polyether complexes. PEO chains adopt an extended helical conformation with repeat units consisting of seven —O—CH₂—CH₂— groups in two turns of the helix. Chains can wrap around ions forming particularly stable “crown-ether-like” multinuclear coordination complexes. In this way, ion-polymer complexes are obtained, with the cations coordinated by the ether oxygens; the anions also exist within the polymer matrix [Boulineau et al., Dalt Trans 2010, 39:6310-6316].

As shown in FIGS. 4B-4E, the mass spectrum of PLA-LiTFSI exhibited four peaks of 51, 62, 63 and 145 mass units, which are attributed to C₂H₄OLi, C₃H₃OLi, C₃H₄OLi and C₇H₆O₃Li fragments.

These results indicate formation of lithium complexes with polylactic acid. Although it is believed that PLA-Li complexes have not been reported previously, these conclusions are indirectly supported by the use of metallic lithium and its complexes as good catalysts in ring-opening polymerization of lactic acid [Sutar et al., Chem Soc Rev 2010, 39:1724-1746; Lee & Hong, Mod Chem Appl 2014, 2:4].

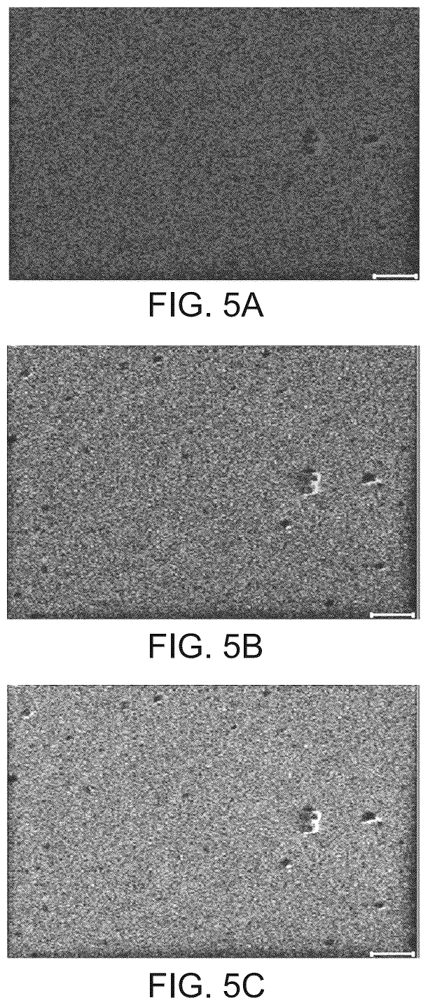

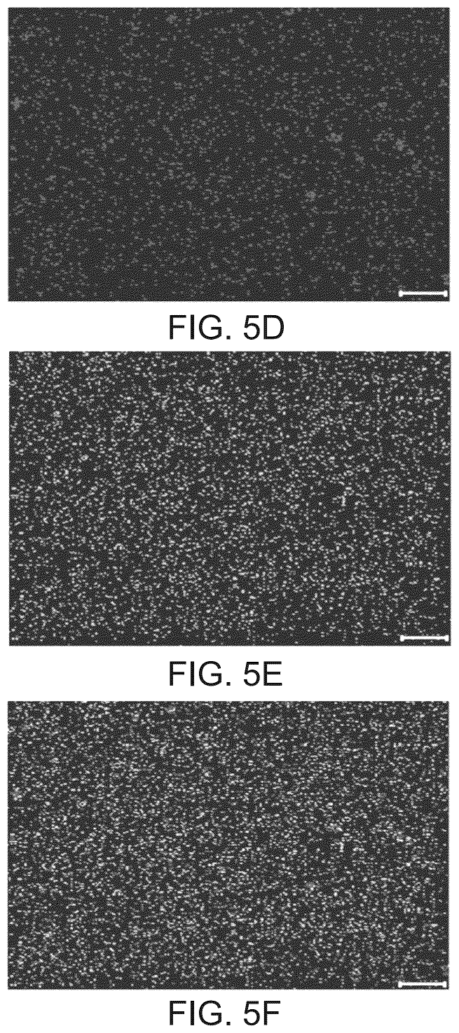

Representative positive-ion images acquired from PLA-PEO-LiTFSI 1% SiO₂ (or alumina) printed samples are shown in FIGS. 5A-5F. As shown therein, there was complete overlapping of polymers and lithium complexes associated with the polymers, with the distribution of each component being relatively homogenous. In addition, bright, high-intensity domains, enriched in lithium were observed.

Without being bound by any particular theory, the observed lithium-enriched domains are attributed to PEO-Li complexes.

From the data presented herein, it is clear that in the printed electrolyte there are no areas comprising pure PEO surrounded by pure PLA, but rather the domains enriched in PEO-Li are formed in a PLA-dominated and PLA-Li matrix.

The amount of complex present in the PEO-enriched domains and surrounding matrix is optionally quantified.

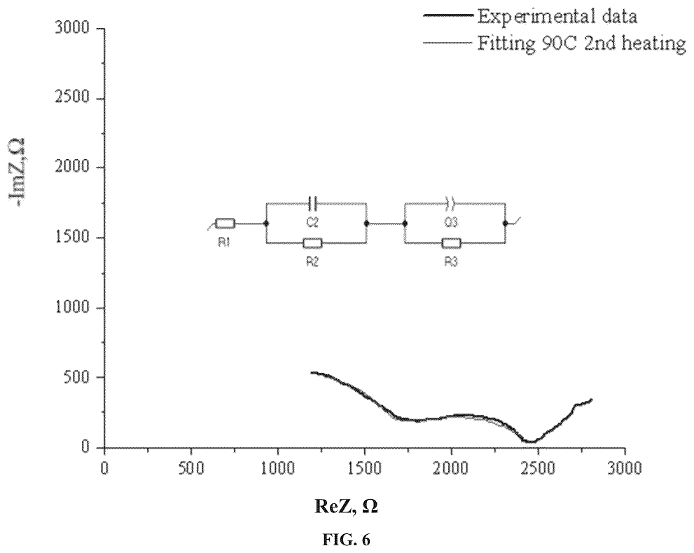

As shown in FIG. 6, the Nyquist plot of cells comprising composite PLA:PEO:LiTFSI+Al₂O₃ electrolyte, sandwiched between two non-blocking lithium electrodes, was characterized by two overlapping depressed semicircles.

The interpretation of the impedance spectrum is often based on equivalent-circuit models that are used to approximate the physicochemical processes that occur in the cell. The equivalent circuit used herein (depicted in FIG. 6) includes the following components: bulk resistance of electrolyte (R_{bulk}), grain-boundary resistance (RGB) and resistance of solid electrolyte interphase (R_{SEI}) formed on lithium electrodes. The validity of choosing this model has been justified by well-fitting results and the capacitances of two arcs, which are about 0.1 nF/cm² and 3 μF/cm².

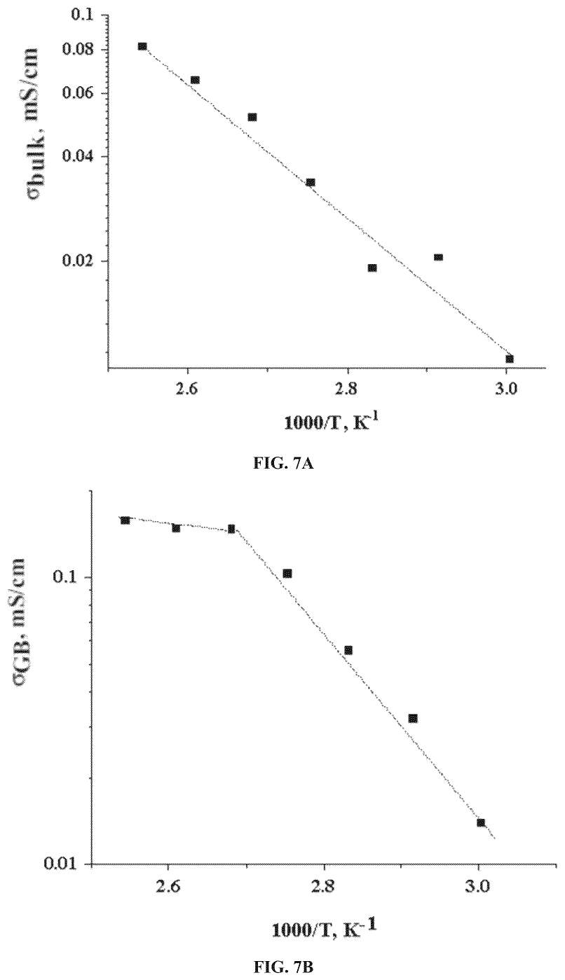

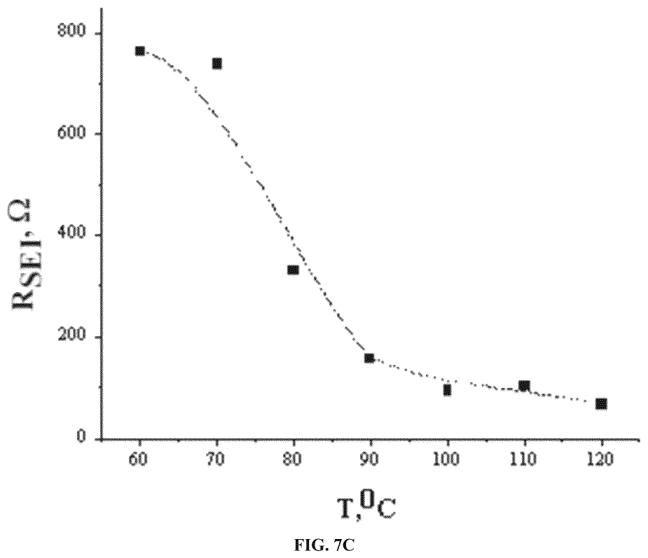

As shown in FIGS. 7A and 7B, the σ_{bulk} (FIG. 7A) and σ_{GB} (FIG. 7B) plots for exemplary silica-containing solid electrolyte obey the Arrhenius temperature dependence.

The bulk conductivity of polymer electrolytes, calculated from the high-frequency intercept of the first arc with the X-axis, was 8*10⁻⁵ S/cm for silica-containing and 3*10⁻⁵ S/cm for alumina-containing PEs at 120° C. For the silica-containing electrolyte at 90° C., the bulk conductivity was 3*10⁻⁵ S/cm. The grain-boundary conductivity of the PE with silica was 1.5*10⁻⁴ S/cm, and with alumina, 1.0*10⁻⁵ S/cm.

Without being bound by any particular theory, it is believed that the latter lower conductivity values can be caused by inferior homogeneity of the slurry used for the extrusion of the filament with alumina, as seen in environmental scanning electron microscopy images.

As shown in FIG. 7C, the R_{SEI} was found to decrease with temperature from 765 ohm·cm² to 156 ohm·cm² and 120 ohm·cm² at 25° C., 90° C. and 120° C., respectively.

The ion-transport mechanism in multiphase and multi-structure systems may be complex for the following reasons. Firstly, the coexistence of different phases, such as an amorphous phase of PEO-LiTFSI complex and various crystalline complexes of PLA and Li⁺ may provide different pathways for ion transport; and secondly, the distribution and structure of the phases may also be intricate. A number of experimental and theoretical studies have investigated ion transport in PEO-based polymer electrolytes. A variety of relevant transport mechanisms, such as the hopping motion of cations through the formation of a weak coordination shell between Li⁺ ions and ether oxygens (EO) of the helix, free ion motion along percolating channels in PEO etc., have been identified [Mogurampelly & Ganesan, Macromolecules 2015, 48:2773-2786; Angell, Solid State Ionics 1986, 18-19:72-88; Fontanella et al., J Appl Phys 1986, 60:2665-2671; Druger et al., Solid State Ionics 1983, 9-10:1115-1120; Livshits et al., Electrochim Acta 2005, 50:3805-3814]. However, among the different controlling factors, the segmental mobility of the polymer backbone has been recognized as a key factor in the cation and anion mobility. In Kang et al. [Macromolecules 2001, 34:4542-4548] it was reported that poly(lactic acid) forms polymeric helices, with orthorhombic or quasi-orthorhombic unit cells. There are four minimum-energy states corresponding to four distinct conformations. As a result of electron delocalization, the structure of the C—O (ester) bond was assumed to maintain the trans conformation. The other two bonds, O—C and C—C are flexible and can assume tt, gg and gt conformations, with the latter two having lowest energy and corresponding to either a 3/1 or a 10/3 helix. The most commonly observed structure of PLA is the α-crystal, in which the chains are in α −10/3 left helical conformation. Under high stress and at about 200° C., a β-crystal structure with chains exhibiting the more extended 3/1 helical conformation can be formed by a melt-recrystallization process. In addition, PLA can develop a unique structure called the mesophase, which has an intermediate order between that of the crystalline state and the amorphous state [Wang et al., Soft Matter 2014, 10:1512-1518; Kang et al., Macromolecules 2001, 34:4542-4548].

Without being bound by any particular theory, it is believed that while an improved order of the crystalline domains was found by the DSC in the sample prepared by fused filament fabrication, the mesophase melted very quickly upon printing, resulting in chain randomization and the release of the constraints on the thermodynamic relaxation of the oriented amorphous chains. This is supported by the decrease of the reduced crystallinity of printed electrolytes when compared to filaments (as shown in Table 1). Chain-relaxation motions have a beneficial effect on the occurrence of the conformational rearrangements that are necessary for Li-ion transport. The conductivity of printed LiTFSI:(PLA-PEO) Al₂O₃ or SiO₂ electrolytes is lower than that reported for neat LiTFSI:PEO electrolytes [Marzantowicz et al., J Power Sources 2006, 159:420-430]. It is further believed that this may be associated with stronger lithium coordination by ester oxygens of the PLA chains than by ether oxygens of PEO chains. In addition, as polymers were initially suspended in different solvents, this may lead to the incomplete mixability.

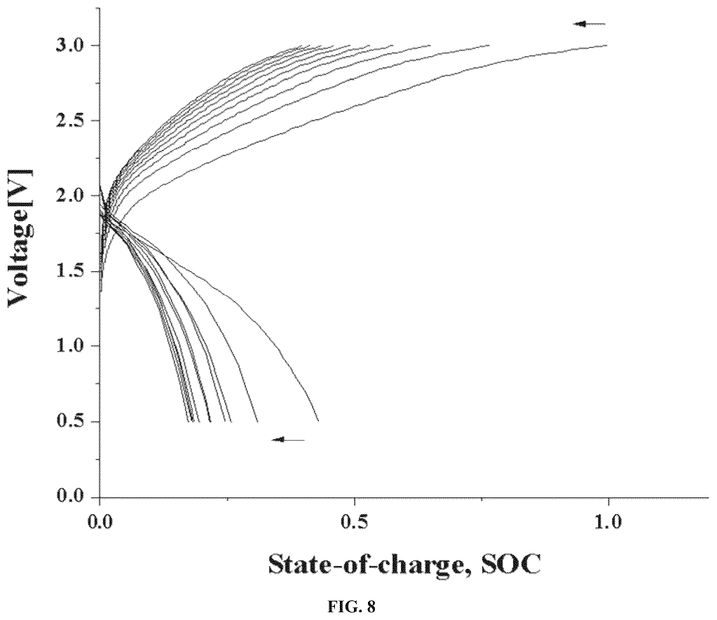

An exemplary all-solid-state printed battery was prepared by placing the LiTFSI:PEO:PLA+1% SiO₂ electrolyte between printed LFP-PLA and LTO-PLA disc-shape electrodes. The cathode and the anode contained 50% PLA, 25% LFP or LTO and the rest was C65 carbon and multi-walled carbon nanotubes (MWCNTs), as in Ragones et al. [Sustainable Energy Fuels 2018, 2:1542-1549]. The electrochemical cell properties were tested at 90° C., and the obtained charge/discharge curves are shown in FIG. 8.

It is believed that this is the first presentation of solid battery printed by fused filament fabrication.

Without being bound by any particular theory, it is believed that absence of lithium imide salt and PEO in the cathode and the anode was associated with high internal resistance of battery, low capacity and sloping charge/discharge profiles; and that preparation of electrodes comprising lithium imide salt and PEO would significantly enhance battery performance.

Ion transport is optionally further studied, for example, to achieve an optimized composition and printing procedure of all battery components.

### Example 2

### Battery in Form of Coaxial Filament

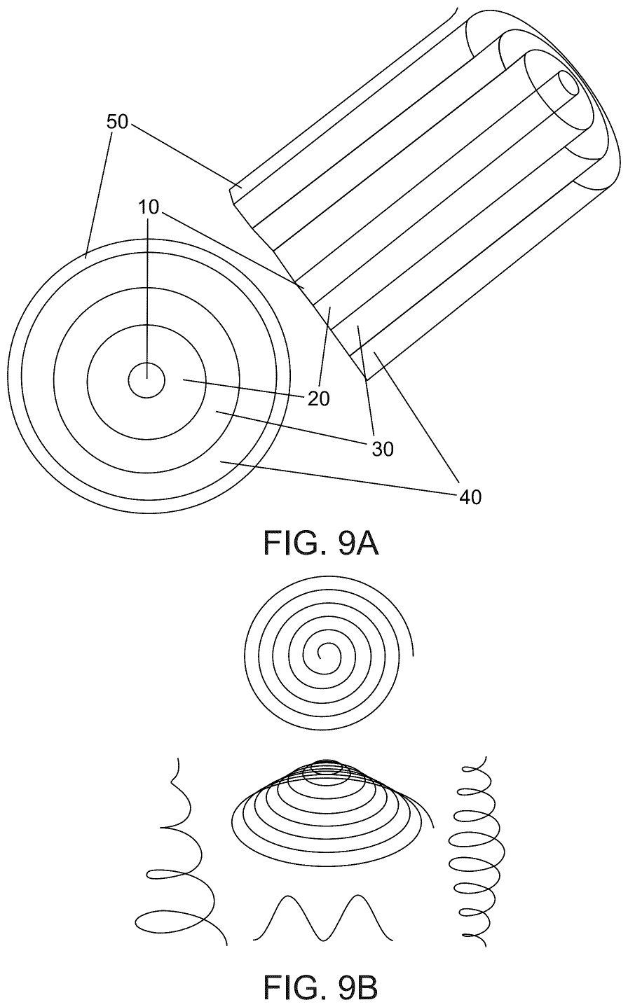

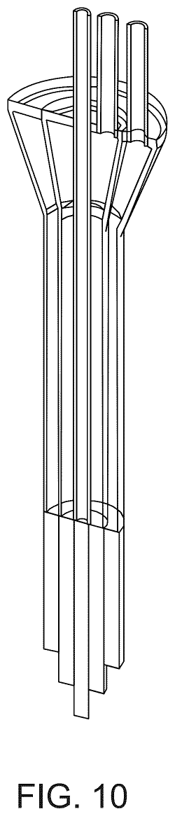

Thermoplastic polymer-based materials such as described hereinabove are used to construct a multi-coaxial, cable-type design, as depicted in FIG. 9A, wherein an inner electrode 20 (anode or cathode) incorporates current collector 10 (thus forming a core/shell structure), and is enwrapped by a solid electrolyte 30 and outer electrode 40. The outer electrode, in turn, is enclosed in a thin layer of a current collector 50.

Such a design is optionally used to construct a flexible 3D printed battery. The design can provide enhanced interfacial areas between current collectors and electrodes and between electrolyte and electrodes, thus significantly facilitating ion transfer by reducing tortuosity in the migration pathway. This is expected to result in high power capability of the battery.

As exemplified in FIG. 9B, such a flexible coaxial filament may optionally be used for tailored-to-application shape networks, e.g., using a filament-based 3D printing technique such as fused filament fabrication. As the filament comprises all of the essential components of a battery, the final shape network of the filament is not critical to battery operation.

FIG. 10 schematically depicts an optional design of an extrusion nozzle which may be used to manufacture a filament such as shown in FIG. 9A. The extrusion nozzle optionally contains three to five input channels, through which melted slurries for current collector, cathode, solid electrolyte and anode may optionally flow to form a multi-coaxial cable-type battery at the joint output of the extruder. Special attention may be paid to the content and melting points of polymer binders in order to eliminate mixing and deterioration of individual mechanical and electrochemical properties of the electrodes and the electrolyte.

Furthermore, it is noted that multilayer, coaxial-cable extrusion dies are produced by SPIDER Industrial Co. Ltd. and triple-layer co-extrusion cross heads and extrusion lines by Singcheer Ltd. Moreover, structured multi-material filaments for 3D printing of optoelectronics have been recently reported by Loke et al. [Nat Commun 2019, 10:4010]. The possibility of 3D printing of complex spiral structures of graphene-filled-PLA current collectors and LTO-PLA anodes has been demonstrated in Ragones et al. [Sustainable Energy Fuels 2018, 2:1542-1549], the contents of which are incorporated herein by reference.

### Example 3

### Battery in Form of Film

Thermoplastic polymer-based materials such as described hereinabove are used to construct a multi-coaxial film-type design, wherein two electrode layers separated by a solid electrolyte layer, and enclosed by two current collector layers, and all the layers are configured as thin parallel sheets (the layers and their order are as described in Example 2, except that the layers are sheet-like rather than cylindrical).

The obtained laminar design is optionally used to construct a flexible battery, optionally by co-extrusion of all of the layers (e.g., using a suitably configured laminar extrusion die).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A composition-of-matter comprising:
a first layer which comprises a first thermoplastic polymer and a substance capable of reversibly releasing lithium or a delithiated form of said substance,
a second layer comprising a second thermoplastic polymer and being capable of conducting lithium ions, and
a third layer which comprises a third thermoplastic polymer and a substance capable of reversibly releasing lithium or a delithiated form of said substance,
wherein said first layer and said third layer are separated by said second layer.

2. The composition-of-matter of claim 1, further comprising at least one layer comprising a substance capable of serving as a current collector, each of said at least one layer being in contact with said first layer and/or said third layer.

3. The composition of claim 1, wherein at least 20 weight percent of said first layer is said first thermoplastic polymer, at least 20 weight percent of said second layer is said second thermoplastic polymer, and/or at least 20 weight percent of said third layer is said third thermoplastic polymer.

4. The composition-of-matter of claim 1, being in a form of a filament.

5. The composition-of-matter of claim 4, wherein said first layer, said second layer and said third layer are coaxial.

6. The composition-of-matter of claim 1, being in a form of a film.

7. The composition-of-matter of claim 6, wherein said first layer, said second layer and said third layer are in a form of sheets parallel to the film.

8. (canceled)

9. The composition-of-matter of claim 1, wherein said second thermoplastic polymer comprises a mixture of polylactic acid and polyethylene oxide.

10. The composition-of-matter of claim 1, wherein said second layer comprises a substance selected from the group consisting of silica and alumina.

11. The composition-of-matter of claim 1, wherein said second layer comprises a lithium salt.

12-13. (canceled)

14. The composition-of-matter of claim 1, wherein said first layer and/or said third layer further comprises an electrically conductive substance.

15. The composition-of-matter of claim 14, wherein said electrically conductive substance comprises carbon particles.

16. The composition-of-matter of claim 1, wherein said first layer and/or said third layer further comprises a lithium salt.

17. (canceled)

18. A method of preparing the composition-of-matter of claim 1, the method comprising co-extruding said first layer, said second layer and said third layer.

19. A method of manufacturing an electrochemical system which comprises at least two lithium-based electrodes and optionally at least one current collector, the method comprising dispensing the composition-of-matter of claim 1, wherein said dispensing comprises co-extruding said first layer, said second layer and said third layer, said first layer and said third layer each forming a lithium-based electrode of the electrochemical system.

20. The method of claim 18, wherein said composition-of-matter further comprises at least one layer comprising a substance capable of serving as a current collector, the method further comprising co-extruding said at least one layer comprising a substance capable of serving as a current collector with said first layer, said second layer and said third layer.

21-33. (canceled)

34. An electrochemical system comprising the composition of matter of claim 1, wherein said first layer and said third layer are each a lithium-based electrode.

35. (canceled)

36. A battery comprising at least one electrochemical system according to claim 34, wherein said first layer and said third layer comprise different substances capable of reversibly releasing lithium or a delithiated form of said substances.

37-38. (canceled)

39. A supercapacitor comprising at least one electrochemical system according to claim 34.

40. The supercapacitor of claim 39, wherein said first layer and said third layer comprise the same substance capable of reversibly releasing lithium or a delithiated form of said substance.
